(19) United States
(12) Patent Application Publication
(10) Pub. No.: US 2009/0270264 A1
(43) Pub. Date: Oct. 29, 2009

(54) SYSTEM AND METHOD FOR THE DECONVOLUTION OF MIXED DNA PROFILES USING A PROPORTIONATELY SHARED ALLELE APPROACH

(75) Inventor: Thomas L. Overson, Fayetteville, GA (US)

Correspondence Address: United States Army Medical Research;and Material Command MCMR-ZA-J, 504 Scott Street, Fort Detrick, MD, 21702-5012, US

(73) Assignee: United States Army as represenfed by the Secretary of the Army, on behalf of USACIDC, Fort Detrick, MD (US)

(21) Appl. No.: 12/421,124

(22) Filed: Apr. 9, 2009

Related U.S. Application Data
(60) Provisional application No. 61/043,693, filed on Apr. 9, 2008.

(51) Int. Cl. C40B 20/06; C40B 60/10

(52) U.S. Cl. 506/5; 506/38

(57) ABSTRACT

A total forensic DNA casework management system and method for the deconvolution of mixed DNA samples using a novel, 3-rule algorithm to determine the proportional allele sharing of the sample's contributors. The process is fully document, can assess and process DNA anomalies and artifacts, and transforms raw STR data to produce final DNA profile types, peak height ratios, proportions, fitting criteria and associated graphs.

### CROSS-REFERENCE TO RELATED APPLICATION

This application claims the benefit of Provisional Application No. 61/043,693, filed Apr. 9, 2008 the contents of which are hereby incorporated by reference in their entirety.

### RIGHTS

This invention was made with support from the United States Government, specifically, the United States Army Criminal Investigation Laboratory, the United States has certain rights in this invention.

### FIELD AND BACKGROUND

The invention is related to methods of resolving a sample containing the DNA of more than one individual into a genotype profile for each individual in the sample.

In forensic science, DNA samples are often derived from more than one individual. When DNA is extracted from a biological stain which contains body fluids or tissue from more than one individual, the result is often a mixed short tandem repeat STR profile. This consists essentially of one person's STR profile superimposed on that of another. With the advent of polymerase chain reaction techniques (PCR) [1], short tandem repeat (STR) or “microsatellite” marker polymorphisms [2] became the marker of choice in forensic applications. Microsatellite markers are extremely abundant (>100,000 CA-repeat loci), readily identified, highly polymorphic (hence informative), easily shared (as PCR sequence information, rather than as laboratory reagents), and straightforward to assay via PCR amplification and subsequent size (not sequence) determination with gel electrophoresis [3].

In mixed DNA sample cases, key objectives include elucidating or confirming a mixed DNA sample's component DNA profiles, and determining the mixture ratios. Generally, the genotype of the victim is known, but the genotype of the perpetrator cannot be obtained clearly and directly due to the presence of DNA of another person in the sample. The genotype of each contributor to the DNA mixture must be deciphered first before further investigation.

The results of a DNA analysis are usually represented as an electropherogram (EPG) measuring responses in relative fluorescence unites (RFU) and the alleles in the mixture correspond to peaks with a given height an area around each allele. The band intensity around each allele in the relative fluorescence unites represented, for example, through their peak areas, contains important information about the composition of the mixture.

In the PCR amplification of a mixture, the amount of each PCR product scales in rough proportion to relative weighting of each component DNA template. This holds true whether the PCRs are done separately, or combined in a multiplex reaction [4].

Until now, the deconvolution of mixed DNA profiles contributed by multiple people has been one of the most challenging tasks facing forensic scientists. Part of the difficulty derives from the large number of possible genotype combinations that can be exhibited by the multiple contributors in the mixed DNA profile.

### General Traditional Methodology for Interpreting a Sample [5]

Step 1: identify the presence of a mixture

Step 2: identify the number of contributors to a mixture

Step 3: determine the approximate ‘ratio’ of the components in the mixture

Step 4: determine the possible pairwise combinations for the components of the mixture

Step 5: compare the resultant profiles for the possible components of the mixture with those from the reference samples

Early methods to resolve the genotype profile of contributors in a sample used loci with four alleles to estimate the mass ratio between the two contributors [6]. For a locus with four detected alleles, each contributor has to have two different alleles with no shared allele between the two contributors. Therefore, only one allele assignment structure is possible (two heterozygotes). For loci with only two or three alleles more than one possible allele assignment structure is possible at each locus. To determine the genotype profile of an individual at two- or three-allele loci, an initial-guess mass ratio derived from the four-allele loci was used to estimate and evaluate all the possible allele assignment combinations that could be made by the contributors to the sample. The mass ratio at the two- and three-allele loci that best fit the observed relative allele peak areas was identified as the contributor's genotype profiles. This procedure was labor-intensive, and yielded a conservative resolution result [7, 8].

Two such methods are in common use to report DNA profiles: these are the classical profile probability approach and the likelihood ratio approach [9, 10].

### The Profile Probability Approach

The profile probability approach presents the probability of the evidentiary DNA profile (E) under a stated hypothesis (Hₒ). This hypothesis may be as simple as saying that the DNA profile is from a person unrelated to the suspect. The probability is written formally as Pr(E|Hₒ), where Pr is an abbreviation for ‘probability’ and the vertical line, or conditioning bar, is an abbreviation for ‘given’. For a single-contributor stain, under the approximation that profiles from unrelated people are independent, this probability is the frequency of occurrence of the profile in the population [8].

### The Likelihood Ratio (LR)

An extension of the profile probability approach works with the probabilities of the evidence under two or more alternative hypotheses about the source(s) of the profile and is known, generally, as the Likelihood Ratio (LR). A typical analysis of a crime sample has the prosecution hypothesis (Hₚ) and the defense hypothesis (H_{d}). For a profile with more than one contributor, the prosecution may hypothesize that the suspect (S) and one unknown (U) person were the contributors, whereas the defense may hypothesize that there were two unknown contributors U1 and U2. The likelihood ratio (LR) compares the probabilities of the evidence under these alternative hypotheses:

$$LR = \frac{Pr ( E \vert {H}_{p} )}{Pr ( E \vert {H}_{d} )}$$

If the LR is greater than one, then the evidence favors Hₚ but if it is less than one then the evidence favors H_{d}. In the single-contributor case, the probability of the evidence profile under Hₚ (the suspect is the contributor) is one and the LR reduces to the reciprocal of the probability of the stain profile if it did not come from the suspect. This is just the population frequency of the profile as would have been given by the profile probability approach.

However, under certain circumstances, involving low level crime stain profiles, the probability of the numerator Pr(E|Hₚ) is less than one. When this happens the LR gives a number that is less than that obtained using the profile probability approach. Examples are PCR stutter and drop-out (defined below).

### Random Man Not Excluded (RMNE)

The probability of exclusion Pr(Ex), or random man not excluded (RMNE) [11] or the complementary probability of inclusion Pr(I) entails a binary view of alleles, meaning that alleles are only present or absent, and further if present are observed. In particular it is problematical to apply the method when there are loci which, under the hypothesis being considered of the suspect at hand, appear to have alleles that have dropped out completely and are therefore not detected. The advantage of the LR framework is that stutter and dropout can be assessed probabilistically [12], and it is the only way to provide a meaningful calculation based on the probability of the evidence under Hₚ and H_{d}.

The RMNE method has considerable intuitive appeal but usually entails an unrealistically simple model of DNA evidence and is therefore restricted in its use to unambiguous profiles. Even in those cases RMNE has the further shortcomings as it does not make full use of the evidence. A likelihood ratio approach is therefore, generally preferred [8].

Various advantages and disadvantages have been suggested in relation to the LR and RMNE approaches; summarized by Clayton and Buckleton [10].

Effort is usually made by the reporting officer to ensure that the LR given in court is conservative. This is attempted by limiting the accepted combinations in the numerator and allowing all reasonable alternatives in the denominator. This approach relies on expert opinion and effectively gives a weight of 0 or 1 to each genotype combination depending on whether the analyst considers them to be possible or impossible based on the peak area information [13]. Such partitioning will not lead to the correct likelihood ratio since all possible contributing genotype combinations should have some “weight” between 0 and 1. This logical failing has naturally led to the development of alternative approaches to take account of weighting possible genotypes. These include the methods described by Evett et al. [14], Gill et al. [6] and Perlin and Szabady [4] that treat peak areas as random variables and determines the probability of these peaks for any given set of contributing genotypes. These probabilities can be shown to act as the weights previously mentioned. The use of automated sequencer technology makes it relatively simple to collect additional quantitative information (i.e. allele peak height and peak area).

### Restricted and Unrestricted Combinatorial Approach

The likelihood ratio approach is, itself, divided into two camps: the unrestricted and restricted combinatorial approach. The likelihood ratio method using the unrestricted combinatorial approach examines all possible sets of genotypes consistent with the alternative hypotheses of Hp and Hd and does not take into account peak heights and areas [15, 16].

The restricted combinatorial (binary) model [6] starts from the position that all alternatives are considered possible unless the combination gives a poor fit to the peak height/areas. If the genotype of interest is the minor component, then interpretation is more complex since other considerations include drop-out, stutter and masking by major alleles. A good understanding of the characteristics of H_{b} (heterozygote balance) and Mₓ (the mixture proportion) are needed to properly implement either approach [5, 6, 10, 17]. The principle followed is to assess the combinations that would be expected to give a reasonable fit to the peak areas, eliminating those that are unreasonable. To do this it is necessary to make an assessment in relation to the heterozygote balance (H_{b}) and mixture proportion (Mₓ) [9, 15−17]. This method requires an iterative search for the optimum mass ratio to fit the allele peaks at each locus that an individual can contribute to a sample. For each mass ratio used to fit each possible genotype profile, the residuals between the expected allele peak areas and those obtained from the measured allele peaks are calculated. The smallest residual at each locus is added to the minimum residuals similarly derived from allele peak data available at other loci. The genotype combinations that give the overall lowest minimum residual are selected to be the best-fit genotype combinations for the loci. This method is limiting and artificial because a finite set of prior-determined mass ratios is used to calculate the fitting residual. Further, this method is computationally intensive because iterations are involved in searching for the best-fit genotype combinations. Clayton and Buckleton assess the limitations of the restricted combinatorial (binary) model [10]. The LR method of DNA deconvolution is utilized in services provided by the Forensic Science Services, Birmingham, UK and is the subject of U.S. patent application Ser. No. 10/977,698 to Gill et al.

### Linear Mixture Analysis (LMA)

In 2001, Mark Perlin and Beata Szababy developed the Linear Mixture Analysis (LMA) method to resolve DNA mixtures using quantitative allele peak data [4]. In this method, all the quantitative allele peak data of all loci in a sample are integrated into a single matrix computation. This method imposes the same mass ratio to all loci analyzed in the mixture. This is in contrast to the observation that the best-fit mass ratio may vary from locus to locus in a sample, due to unequal DNA amplification and other nonidealities. The imposition of the same weight fractions to fit all loci will present a limitation on that set of weight fractions being optimal for all loci. The LMA method for deconvolution of DNA mixtures is available as a commercial package under the trade name TRUEALLELE as sold by Cybergenetics, Pittsburgh, Pa. and is the subject of U.S. patent application Ser. No. 09/776,096 to Perlin.

### Least-Square Deconvolution (LSD)

Like LSM, Least-Square Deconvolution (LSD) uses quantitative allele peak data and linear algebra principals to solve the DNA mixture problem [18]. LSD operates locus by locus to fit each locus separately, followed by pulling together only those loci at which resolution is clear and consistent to form a composite profile for each of the two contributors. In LMA, all available loci are processed as one entity, and a single mass ratio is sought to fit the given allele peak data simultaneously at all loci.

When LMA is used to resolve a two-people DNA mixture, the genotype of one of the two contributors also has to be known, and entered into the LMA algorithm to derive the other contributor's genotype. When using LSD to resolve such mixed DNA profiles, no a priori genotype information is necessary. The best-fit genotype combination pair for both contributors is obtained simultaneously in one step. The LSD method for DNA convolution is available to the law enforcement and academic community from the Laboratory for Information Technologies, University of Tennessee, USA. The method is also the subject of U.S. Pat. No. 7,162,372 and U.S. patent application Ser. No. 11/413,183 both to Wang et al.

However, LSD is of limited application when DNA mass proportions are close to 1:1, and 1:2 (with 1:2 peak height ratio also). Furthermore the technique is only appropriate for two-person mixtures. Efforts to apply LSD to three-person mixtures by incorporating a known profile have been demonstrated, but even then some loci remain hard to resolve (2 & 3-allele loci). This method of mixture interpretation has not been widely adopted because of the complexity of the associated calculations.

### Expert Systems—Bayesian Network Model

Perlin and Szabady [4] and Wang et al. [18] used the numerical methods of linear mixture analysis (LMA) and least square deconvolution (LSD) for separating mixture profiles using peak area information. Both methods are based on enumerating a complete set of possible genotypes that may have generated the mixture profile, on the assumptions that the mixture proportion of the contributors' DNA in the sample is constant across markers, so that the peak area of an allele will be approximately proportional to the proportion of that allele in the mixture. This may be used to calculate—via a least squares heuristic—an estimate for the mixture proportion. The major difference between the two methods is that Perlin and Szabady seek a single mixture proportion estimated using all of the markers simultaneously, whilst Wang et al. estimate a mixture proportion for each marker separately and then eliminate genotype combinations giving inconsistent estimates of this proportion across markers. Thus the methods of both [4] and [18] share features with that of Bill et al. [13].

The methods utilizing peak area information described above are not probabilistic in nature, nor do they use information about allele frequency. In contrast, the methodology proposed in Evett et al. [14] combines a model using the gene frequencies with a model describing variability in scaled peak areas to calculate likelihood ratios and study their sensitivity to assumptions about the mixture proportions.

The approach proposed by Bill et al. incorporates elements similar to all of those described above, but unifies these in a single Bayesian network model producing an expert system [13]. The result of the effort is a computer program package called PENDULUM. The program uses a least squares method to estimate the preamplification mixture proportion for two potential contributors. It then calculates the heterozygous balance for all of the potential sets of genotypes. A list of “possible” genotypes is generated using a set of heuristic rules. External to the program the candidate genotypes may then be used to formulate likelihood ratios (LR) that are based on alternative casework propositions [13]. The PENDULUM program is available as a commercial package under the trade name FSS-i³ EXPERT SYSTEMS, as sold by Promega Corp., Madison, Wis.

However, as a probabilistic driven expert system, PENDULUM is not appropriate for generating data that may be entered into databases such as CODIS which require expert human evaluation prior to submission. Also, the performance of the system is sensitive to large changes in the scaling factors used to model the variation in the amplification and measurement processes. This is a serious problem which needs attention [13]. Furthermore, the complexity of the software and the associated calculations make this package undesirable for use in preparing evidence that will have to be explained to laypersons in a typical criminal jury.

Given the advancements in deconvolution and DNA mixture assessment described above, it is worth describing the updated protocol:

### General Updated Methodology for Interpreting a Sample [8]

Step 1: Identify the presence of a mixture

Step 2: Designation of allelic peaks

Step 3: Identify the number of contributors in the mixture

Step 4: Estimation of the mixture proportion or ratio of the individuals contributing to the mixture

Step 5: Consideration of all possible genotype combinations

Step 6: Compare reference samples

### Identifying the Presence of a DNA Mixture

A mixed STR profile is typically indicated by the presence of three (or more) bands at any locus [5]. However, the presence of additional bands at any particular locus is not necessarily diagnostic of a mixture because other circumstances can lead to extra bands, giving the (wrong) impression of a mixed STR profile.

### Identifying the Presence of a DNA Mixture

A mixed STR profile is typically indicated by the presence of three (or more) bands at any locus [5]. However, the presence of additional bands at any particular locus is not necessarily diagnostic of a mixture because other circumstances can lead to extra bands, giving the (wrong) impression of a mixed STR profile.

### Stutter Bands

The first and most common cause of extra bands are usually termed ‘stutters’ and are caused by slippage of the Taq polymerase enzyme during copying of the STR allele. In simple, tetramerically repeating STR loci the position of a stutter will correspond to one full repeat unit shorter than the main band. Stutter bands occur frequently when tetrameric STR loci are co-amplified in a multiplexed system and are a normal consequence of amplification reactions which are not optimal for all of the constituent loci. Stutter bands have smaller peak area in relation to the main band; usually of the order of 15% or less of the peak area of the main band [5].

### Non-Specific Artifacts

Non-specific artifacts are usually the result of non-specific priming in a multiplex system. In general, the more loci that are co-amplified, the greater will be the propensity for non-specific priming to occur because there will more primer pairs in the reaction mixture. Almost all of the artifacts encountered to date have low peak areas, many have an aberrant peak morphology and, moreover, most do not fall within the allelic range of the locus or loci with the appropriate colored fluorescent dye [5].

### Miscellaneous Artifacts

For a comprehensive overview of other artifacts affecting the diagnosis of a mixed STR profile including, N-bands, peak “pull-up” and masking see Clayton et al. [5]. Any deconvolution methodology and system must account for such anomalies to be effective in a present-day forensics laboratory.

There is, therefore, a need in the art for an efficient, accurate and simple method to resolve a sample mixture of DNA into the genotype of each individual whose DNA is contained within the mixture. Further, that this method and system be adjustable for the effects of stutter and able to be conditioned upon known reference profiles. Further, that such a deconvolution method and system to be applicable to DNA mixture profiles involving three or more individuals. Further still that, said method and system of DNA deconvolution present a “turn-key” solution to the forensic community providing all necessary tools for evaluating genetic data to include: matching, statistics, and QA/QC evaluation.

### BRIEF DESCRIPTION OF THE DRAWINGS

In the drawings:

FIG. 1 is a table describing the three rules of the preferred method embodiment of the invention.

FIG. 2 is an eletropherogram of alleles A and B demonstrating the assumption of Rule 1 of the invention.

FIG. 3 is an electropherogram of alleles A, B and C demonstrating Rule 2 of the invention.

FIG. 4 is an electropherogram of alleles A and B demonstrating Rule 3 of the invention.

FIG. 5 is an electropherogram of alleles A, B and C demonstrating Rule 3 of the invention.

FIG. 6 is a flow diagram demonstrating the upper and lower boundary conditions when ratios and proportions are not calculated.

FIG. 7 is a diagram displaying combinations of allele pairings from a 2-person mixed sample.

FIG. 8 is a diagram displaying combinations of allele pairings from a 3-person mixed sample.

FIG. 9 is an eletropherogram of alleles A and B demonstrating the assumption of Rule 1 of the invention.

FIG. 10 is a flow diagram of the preferred system embodiment of the invention.

FIG. 11 is a flow diagram of a secure network running software utilizing the preferred system and method of the invention.

FIG. 12 shows the output of software implementing the preferred system and method of the invention generating a Main Screen View.

FIG. 13 shows the output of software implementing the preferred system and method of the invention generating a QA Check View.

FIG. 14 shows the output of software implementing the preferred system and method of the invention generating a Samples View.

FIG. 15 shows the output of software implementing the preferred system and method of the invention generating a Matching View.

FIG. 16 shows the output of software implementing the preferred system and method of the invention generating a Foreign Allele View.

FIG. 17 shows the output of software implementing the preferred system and method of the invention generating a Single Source Stats View.

FIG. 18 shows the output of software implementing the preferred system and method of the invention generating a Multiple Source (Mixture) Stats View.

FIG. 19 shows the output of software implementing the preferred system and method of the invention generating a CPI Stats View.

FIG. 20 shows the output of software implementing the preferred system and method of the invention generating a LR Stats View.

FIG. 21 shows the output of software implementing the preferred system and method of the invention generating a graphical user-interface for the mixture interpretation.

### BRIEF DESCRIPTION OF THE EMBODIMENTS

The system and method of the preferred embodiment essentially performs all steps that a forensic DNA expert would desire to do on their data. Traditionally, this is done using pen and paper. This allows for numerous opportunities for errors. Such errors include transcription errors, calculation errors, switching samples, and reading errors from poorly written and documented pen and paper approaches.

The system and method of the preferred embodiment is ideal for compiling the information in a forensic DNA case in a manner that will allow the examiner to clearly convey the results of the analysis in both written report form and in oral testimony during court proceedings. It can also be used as QA/QC tool to track contamination issues, show concordance of examiners during the peer review process, and compare results from different labs and/or concordance and reference samples such as those provided by NIST.

The various embodiments of the invention herein include a total forensic DNA casework management tool. One novel aspect of the management tool embodiment of the invention is that it presents raw, tabular data in a manner that allows for the deconvolution of both two- and three-person DNA mixtures into individual DNA profiles. Using a novel algorithm to determine the proportional allele sharing of the contributors, the embodiments of this invention rely on three rules: 1) peak height ratios are equal to one for the homozygous and heterozygous case (i.e. AA, AB); 2) shared markers are shared between contributors in the same proportion as the unshared markers present; and, 3) minimum peak heights are maintained, taking priority over rules 1 and 2 above. The various embodiments of the invention can also account for 0-100% of stutter as determined by the user. Also, the various embodiments of the invention allow the user to consider one or more alleles extraneous to the calculation. The process is fully document and a summary is produced indicating final DNA profile types, peak height ratios, proportions, fitting criteria and associated graphs.

It is another feature of the various embodiments of the invention to be capable of performing numerous forensic functions such as matching, quality control checks, documentation, statistical analysis and the creation of files suitable for submission and entry into the CODIS database. Data produced by the various embodiments of the invention may be stored for later retrieval and compared with other data sets by the same examiner or between different examiners either locally or remotely.

In one embodiment of the invention, there are several matching functions that may be done. A known reference sample can be compared to the questioned samples to determine where an exact match or an inclusive match is found. Questioned samples may be compared to other questioned samples or the references. Multiple samples can be combined into a single reference and then that combined reference can be searched against all profiles. This can be helpful to determine if both Suspects 1 and 2 are found together in any samples, or if there are any alleles present in the questioned samples that are not accounted for by the known references associated with the case. Many times it can be challenging to determine if there is any evidence of an additional unknown contributor in a case with several suspects, a consensual partner, and victim references and there are multiple questioned profiles that have 2, 3, or more contributors. The method and system disclosed herein makes such samples are immediately apparent.

In certain embodiments of this invention, all checks of ladders, positive and negative controls, and quality assurance samples such as extractions controls can both be checked for accuracy and searched against all other samples in the case. Samples may also be checked for unaccounted for alleles at the examiner level against a staff database as part of the initial data evaluation. Most labs do this using their CODIS software but many times the report has already been issued by then. All of this information is available in print out form for a hard copy case file.

Some embodiments of this invention incorporate the use of several separate statistical calculators. For instance, by way of non-limiting examples, such calculators may be used to determine single source (frequency of occurrence), combined probability of inclusion/exclusion CPI/CPE, and likelihood ratio methods, as well as a mixture calculator. The mixture calculator, as described herein, is similar to the frequency of occurrence calculator, but it allows for a situation where the conservative choice using 11,11; 11,12; and 11,13 is needed. It is also possible to allow for an 11, any situation if there is concern about allelic dropout. It is important to note that both unrestricted and restricted likelihood ratio calculations are envisioned in the various embodiments of this invention.

The likelihood ratio calculator, as disclosed herein, is especially intuitive to the user, and is a good match for the situation where the Victim, Consensual, and Suspect profiles have been applied to the mixed sample and this combination is fully supported by all peak height ratio and proportion calculations.

Various embodiments of this invention include specific functions for interfacing with the CODIS database. These functions include quality assurance and quality control checks. Non-limiting examples of these checks include, a check for more than two alleles (genetic markers), a check for the X allele, checks for off-scale data and peak height ratios that are less than an acceptable threshold. Other, non-limiting, examples of QA/QC functions disclosed as part of this invention include means for tracking all controls, a system for ensuring that duplicate samples have concordance, and a means for generating all necessary CMF files for uploading the CODIS database. The system disclosed herein may be easily modified to produce files compatible with any database system. Further, the system disclosed herein can generate data that can be analyzed without the need for database integration.

Other available commercial software packages involve mixture deconvolution functions limited to two person mixtures, and none are based on the proportional allele sharing method as described herein. There are software packages that provide for the statistical analysis of results. However, there are no other packages that provide for the matching of known references to the questioned samples, finding alleles not accounted for by the references, and the easy import and export of any or all samples for comparison purposes at this level.

The system and method described herein can correct for stutter, allow for the deconvolution of three person mixtures, and does not preempt human review and interpretation which is a shortcoming of available expert systems. Because of this, all results are suitable for entry into CODIS.

The method and system described herein allows for up to six samples to be set and applied as references. The deconvolution results may be conditioned upon from 1−3 of these references. The resulting mixture deconvolution results must contain the applied reference profiles to be valid. No other software allows for this conditioning of results upon known references.

Inherent in the method and system of the preferred embodiment of the invention is the power and flexibility of performing ratio and proportion calculations on for every allele combination regardless of what restrictions and filters are placed during report generation and data analysis. In other systems known in the art, restrictions are placed on the data prior to performing calculations due to computational complexity inherent in such systems. Because of the simplicity of the preferred system and method embodiments of this invention, such restrictions are not required—and the calculations may be performed on hardware that is customarily found at any forensic laboratory.

The preferred system embodiment of the invention is flexible, allowing for the addition of future DNA kits looking at areas of DNA (loci) not currently in use such as, by way of non-limiting example, plant and animal DNA.

The specific novel features can be summarized:

1. Mixture deconvolution based on proportionate allele sharing as guided by three simple rules.

2. The ability to consider the effects of stutter.

3. The ability to condition the profiles on known reference profiles.

4. The ability to deconvolute 3-person mixtures.

5. A “turn-key” package that offers the forensic DNA examiner all necessary tools for evaluating the results of a forensic DNA case, including matching, statistics, and QA/QC evaluation in addition to mixture deconvolution.

### DETAILED DESCRIPTION OF THE EMBODIMENTS

The practice of the present invention will employ, unless otherwise indicated, conventional methods of chemistry, biochemistry, recombinant DNA techniques and immunology, within the skill of the art.

All publications, patents and patent applications cited herein, whether supra or infra, are hereby incorporated by reference in their entirety.

It must be noted that, as used in this specification and the appended claims, the singular forms “a”, “an” and “the” include plural referents unless the content clearly dictates otherwise. Thus, for example, reference to an antigen includes a mixture of two or more antigens, and the like.

### DEFINITIONS

In describing the present invention, the following terms will be employed, and are intended to be defined as indicated below unless otherwise noted:

The interpretation of mixtures requires the understanding of at least two PCR phenomena assumed to be the result of stochastic variation in the amplification process or sampling of template: heterozygote balance (Hb) and variation in mixture proportion (Mx). In addition we assume that peak area is approximately linearly proportional to the amount of DNA prior to amplification and that contributions from two separate alleles are additive.

Heterozygous balance (Hb) describes the area (or height) difference between the two peaks of a heterozygote. This has been previously defined in two different ways either as the ratio of the smaller area peak to the larger area peak [13]:

$${Hb}_{1} = \frac{{φ}_{smaller}}{{φ}_{larger}}$$

or as the ratio of the high molecular weight (HMW) peak to the lower (LMW):

$${Hb}_{2} = \frac{{φ}_{HMW}}{{φ}_{LMW}}$$

It can be shown, using artificial mixtures, that peak areas corresponding to an allelic position are approximately proportional to the amount of DNA from the contributor However, this proportionality is imprecise and is affected by many factors such as locus; degradation; the presence of stutter; stochastic variation and other artifacts, especially when the concentration of DNA is low.

Allele drop-in: Contamination from a source unassociated with the crime stain manifested as one or two alleles.

Allele drop-out: Low level of DNA insufficiently amplified to give a detectable signal.

Artifact peaks are peaks due to impurities in the DNA samples. Generally, the artifact peaks have one or more of the following three characteristics: (1) about 53% of them are less than 5% of the nearest allele peak's height, (2) some artifact peaks consist of multiple peaks, and the distances among them are always less than 1 bp, and; (3) some artifact peaks are within 0.5 bp of an allelic ladder marker. If a peak satisfies any of the above three rules, the peak can be defined as an artifact peak, and the peak's effect can be eliminated.

“Best-fit” refers to an assumption that the allele peak area/height is proportional to the relative mass proportion of the corresponding DNA allele in the mixture, the returned genotypes at the specified mass proportions would yield a set of allele peak areas/heights that is ‘closest’ to the measured set of allele areas/heights, in the least square sense (as measured by the Euclidean distance metric).

Conservative: 1. An assignment for the weight of evidence that is believed to favor the defense; or, 2. When the evidence is very powerful in one direction, assigning the weight as less than our belief in that direction; or, 3. Lack of conservativeness will often result when the assumptions that underpin a statistical model are seriously violated.

Contamination: Extraneous DNA from a source unassociated with the crime stain—e.g. plastic-ware can be contaminated at manufacturing source.

Continuous approach: The allelic intensity information is used to give a variable, probability, weight to the validity of each genotype set as an explanation, rather than merely binary weights as in the combinatorial approaches.

A DNA or genotype profile is developed from a nucleic acid sample, usually a DNA sample. Sources of nucleic acid include tissue, blood, semen, vaginal smears, sputum, nail scrapings, or saliva.

The DNA of interest can be prepared for analysis by amplification and subsequent separation. Amplification may be performed by any suitable procedures and by using any suitable apparatus available in the art. For example, enzymes can be used to perform an amplification reaction, such as Taq, Pfu, Klenow, Vent, Tth, or Deep Vent. Amplification may be performed under modified conditions that include “hot-start” conditions to prevent nonspecific priming. “Hot-start” amplification may be performed with a polymerase that has an antibody or other peptide tightly bound to it. The polymerase does not become available for amplification until a sufficiently high temperature is reached in the reaction. “Hot start” amplification may also be performed using a physical barrier that separates the primers from the DNA template in the amplification reaction until a temperature sufficiently high to break down the barrier has been reached. Barriers include wax, which does not melt until the temperature of the reaction exceeds the temperature at which the primers will not anneal nonspecifically to DNA.

The products of the amplification reaction are detected as different alleles present at a locus or loci. The alleles of at least one locus are amplified and detected after the amplification reaction. If desired, however, the alleles of multiple loci, e.g., two, three, four, five, six, ten, fifteen, twenty, twenty-five, or thirty, or more different loci may be detected after amplification. Sets of loci may include at least two, three, five, ten, fifteen, twenty, thirty, or fifty loci. Amplification of all of the alleles may be performed in a single amplification reaction or in a multiplex amplification reaction. Alternatively, the sample may be divided into several portions, each of which is amplified with primers that yield product for the alleles present at a single locus.

The different alleles at a locus typically are detected because they differ in size. Alleles can differ in size due to the presence of repeated DNA units within loci. A repeated unit of DNA can be, by way of non-limiting example, a dinucleotide, trinucleotide, tetranucleotide, or pentanucleotide repeat.

The number of repeated units at a locus also varies. The number of repeated units may be, by way of non-limiting example, at least five, at least ten, at least fifteen, at least twenty, at least twenty-five, or at least fifty units. The effect of these repeated units of DNA is the presence of multiple types of alleles that an individual can possess at any given locus that can be detected by size.

Preferably, alleles that harbor different numbers of STR repeat units are detected. More than 8000 STRs (loci) scattered across the 23 pairs of human chromosomes have been collected in the Marshfield Medical Research Foundation in Marshfield, Wis. Preferably, alleles at the 13 core loci used by the FBI Combined DNA Index System (CODIS): CSF1PO, FGA, TH01, TPOX, VWA, D3S1358, D5S818, D7S820, D8S1179, D13S317, D16S539, D18S51, and D21S11 are detected.

It is also contemplated that amplification may be performed to detect an allele by amplifying microsatellite DNA repeats, DNA flanking Alu repeat sequences, or any other known polymorphic region of DNA that can be distinguished based on the size of different alleles.

The identity of the alleles at one or more of the loci of the reference sample and/or test sample may be determined by short tandem repeat based investigation.

Whilst the technique is applicable to all loci, the loci for which allele identity is determined may particularly be selected to include one or more of HUMVWFA31, HUMTH01, D21S11, D18S51, HUMFIBRA, D8S1179, HUMAMGXA, HUMAMGY, D3S1358, HUMVWA, D16S539, D2S1338, Amelogenin, D8S1179, D21S11, D18S51, D19S433, HUMTH01, HUMFIBRA/FGA. The loci selected may particularly be each of D3S1358, HUMVWA, D16S539, D2S1338, Amelogenin, D8S179, D21S11, D18S51, D19S433, HUMTH01, HUMFIBRA/FGA.

Any method that separates amplification products based on size and any method that quantitates the amount of the allele present in the sample can be used to prepare the data required for analysis of genotype profiles in the method. The amplification products may be separated by electrophoresis in a gel or capillary, or mass spectrometry. The amount of each allele present may be determined flourometrically in a flourometer, or via ultraviolet spectrometry. For example, a Beckman Biomek® 2000 Liquid Handling System can be used to detect and quantitate alleles present for a locus in a sample. Optical density or optical signal can be used to detect the presence of an allele after gel or capillary electrophoresis.

Preferably, alleles are detected using an ABI Prism 310 Genetic Analyzer, or a HITACHI FMBIO II Fluorescence Imaging System (10). The ABI 310 Genetic Analyzer identifies alleles present at a locus and provides a data output result. One advantage of this instrument is that, in addition to sizing the detected allele signals, the related software can also display their peak heights and automatically calculate the area under each peak.

The HITACHI FMBIO II Fluorescence Imaging System uses gel electrophoresis instead of capillary electrophoresis to separate the alleles of a DNA sample. This system requires much more sample and a longer time to complete a separation. In this genetic analyzer, each allele corresponds to a specific band in a gel lane. The band size for each allele is compared with a well-calibrated allelic ladder to identify the corresponding allele.

If the amplification products are input into an apparatus that both separates and quantitates alleles for a locus in a sample, four different types of peaks can be obtained from these raw data: true or allele peaks, stutter peaks, artifact peaks, and pull up peaks.

Exclusion: Exclusion from a stain: 1. a decision (by the expert) that a particular reference DNA profile does not represent a contributor to the stain; or, 2. a situation in which the reference profile is “excluded” from the stain at one or more loci.

Exclusion at a locus: Exclusion based on the fact that the pattern of the assumed genotypes at a locus that some allele seen in a particular reference DNA profile is not observed in a stain.

Exclusion probability: The probability that a randomly selected DNA profile would be excluded.

Frequency: Rate at which an event occurs. By way of non-limiting example, sample frequency of an allele is the number of occurrences of the allele in a population sample, divided by the sample size; population frequency of a DNA profile is the (unknown) number of times that the profile occurs in the population, divided by the population size.

A genotype or DNA profile is the set of alleles that an individual has at a given locus. A genotype or DNA profile may also comprise the sets of alleles that an individual has at more than one locus. By way of non-limiting example, a genotype or DNA profile may comprise the set of alleles at each of at least 2 loci, 3 loci, 4 loci, 5 loci, 7 loci, 9 loci, 11 loci, 13 loci, or 20 loci.

A genotype profile includes profiles matched to an individual to identify the individual as potentially having contributed to the sample. The genotype profile may be matched to the individual after obtaining a sample from the individual. The genotype profile may also be matched to an individual by comparing it to other genotype profiles in a database. The database may be any public or proprietary database that stores and/or matches genotype profiles. The database may be CODIS, which may be used to store genotype profiles in a national, state, or regional collection, and which may separate these profiles into disjoint parts, such as a convicted offenders database, a forensic DNA database, or a missing persons database.

Likelihood: Conditional probability of an event, where the event is considered as an outcome corresponding to one of several conditions or hypotheses. A non-limiting example of an event is the DNA profile evidence from a crime stain. The probability of the event is conditional upon the hypothesis that may vary. If the DNA profile is a mixture, a typical prosecution hypothesis may be suspect and victim. This is written as Pr(E|H), where E is the event, the vertical bar in between the two terms means “given”, and H is the hypothesis.

Likelihood ratio: Ratio of two likelihoods, i.e. the ratio of two probabilities of the same event (E) under different hypotheses (H1, H2). Written as LR=(E|H1)/(E|H2). Typically H1 corresponds to the prosecution hypothesis and H2 corresponds to the defense hypothesis. If H1 consists of suspect and victim, then the alternative H2 is unknown and victim.

A locus refers to the position occupied by a segment of a specific sequence of base pairs along a gene sequence of DNA. Genes are differentiated by their specific sequences of base pairs at each locus. An allele refers to the specific gene sequence at a locus. At most two possible alleles can be present at one locus of a chromosome pair for each individual: one contributed by the paternal and the other contributed by the maternal source. If these two alleles are the same, the DNA profile is homozygous at that locus. If these two copies are different, the DNA profile is heterozygous at the locus. There are multiple alleles that can be contributed by either parent at each locus.

Minimum Peak Height (mPH) is an “on-the-fly” variable and will have a value of 150 RFUs unless otherwise stated.

Minimum Contributor Proportion (mP) is an “on-the-fly” variable and will have a value of 0 unless otherwise stated.

Peak Height Ratio (PHr) is an “on-the-fly” variable and will have a value of 0.5 unless otherwise stated.

Probability: Long-term rate of occurrence of an event in a conceptually repeatable experiment. Same as expected frequency, the expectation evaluated over cases described by the probability condition; or, a coherent assignment of a number between zero and one that reflects in a fair and reasonable way our belief that the event is true.

Proportion (p) is the proportion of total RFUs of one genotype as compared to the total RFUs (t).

Propositions: The hypothesis of the defense or prosecution arguments that are used to formulate the likelihood ratio.

A pull-up peak is a false peak reading in a color detection channel at the same place on the x access of a true peak reading at a different color detection channel. The dyes used to label amplified DNA fragments fluoresce at different wavelengths. However, there is some overlap in the emission spectra of dyes and, therefore, a blue-labeled DNA fragment will also emit a small proportion of green fluorescence. This spectral overlap is mathematically compensated for using software. However, in the case of overamplified samples in a multiplexed process the software can generate a false peak for a color in the spectral overlap.

Quantitative peak data of ‘true’ alleles are determined at a locus. These measurements may be the peak height or peak area of a signal detected by an instrument or procedure designed to quantify the presence of each allele. The peak height, peak area, and any other measurement that is related to the relative masses of each allele present in the original stain or sample are equivalent. Quantitative allele peak data will be referred to as “peak height,” “peak area,” or “quantitative allele peak data.” Each of these terms is interchangeable.

Restricted combinatorial method: Elaboration of the unrestricted method in which allelic intensity (peak height/area) information is used to restrict the sets of genotypes that are considered plausible explanations.

Short Tandem Repeats (STR) are DNA segments with repeat units of 2 6 bp in length (10). The repeated unit can be of a longer length that ranges from ten to one hundred base pairs. These are medium-length repeats and may be referred to as a Variant Number of Tandem Repeat (VNTR). Repeat units of several hundred to several thousand base pairs may also be present in a locus. These are the long repeat units.

Stutter: An allelic artifact cause by ‘slippage’ of the Taq polymerase enzyme. It is always four bases less than the allele that causes the stutter. Stutters are always found in allelic positions and can compromise interpretation of minor contributors to mixtures.

Stutter peaks are peaks generated by the enzyme's slippage during the amplification process. In most cases, stutter peaks are located on the left side of the associated alleles, and the gene distance between the stutter peak and the associated allele peak is usually less than 4 bp. The height of the stutter peak is usually less than 15% of the height of the corresponding true allele peak.

Total RFUs (t) is the sum of all RFUs at the locus of interest.

True or allele peaks are peaks that indicate the presence of an allele at a locus. The most important characteristic of an allele peak is that the measured peak area or height is roughly proportional to the mass of the corresponding allele in the DNA sample.

Unrestricted combinatorial method: The simple likelihood ratio method of evaluating mixture evidence described in Weir et al. [16] and Clayton and Buckleton [5]. The method assumes a list of all alleles in the mixture, and considers competing hypotheses that various known or unknown profiles are the constituents of the mixture. It uses no information about allelic intensities, hence one set of genotypes whose allele sets are coincident with the mixture is considered to be as valid an explanation of the mixture as any other set.

### The Preferred Method of Mixed Sample DNA Deconvolution

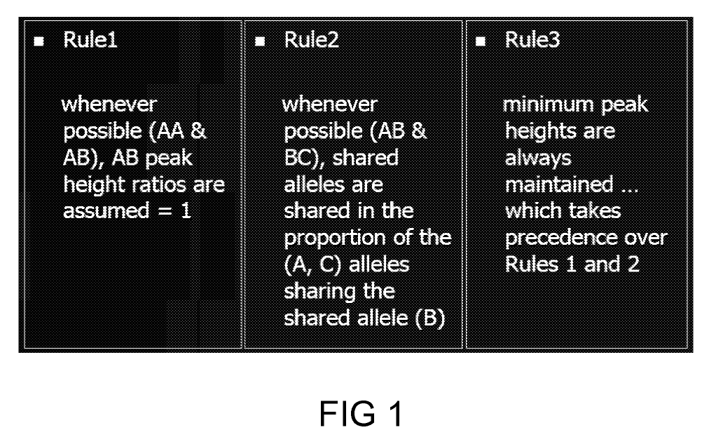

The method disclosed herein removes the analyst bias inherent in known methods by calculating peak height ratios (PHr) and proportions (p) without bias using the same set of calculation rules for every instance. Those rules are shown in FIG. 1.

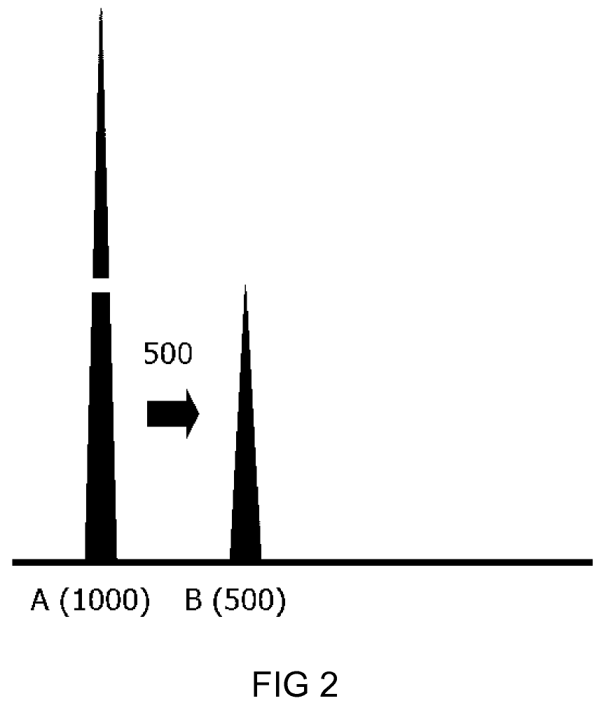

The application of Rule 1 is shown on FIG. 2, wherein a stylized representation of a eletropherogram is shown exhibiting allele peaks corresponding to the A and B allele, with peak heights being measured in RFUs. The peak heights, as shown in FIG. 2 for alleles A and B are 1000 and 500 respectively, with the contributing genotypes being AA and AB (or homozygous and heterozygous).

Using Rule 3 (minimum peak heights), we determine that the peak height difference between alleles A and B is greater than or equal to a predetermined threshold peak (150 is the default). In this case, rule 3 is met (A−B=500≧150). Under Rules 1 and 3, we are therefore free to assume that the A allele contribution of the AB genotype is equal to the peak height of the B allele, making the AB peak height ratio equal to 1 (AB PHr=1). See FIG. 2.

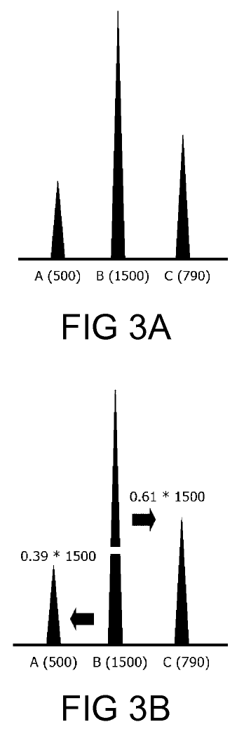

Moving now to Rule 2 and FIG. 3, we see a stylized representation of a electropherogram showing allele peaks corresponding with the A, B and C alleles, peak heights being measures in RFUs. The peak heights, as shown in FIG. 3A for alleles A, B and C are 500, 1500 and 790 respectively.

According to Rule 2, we assume that, for the genotypes AB & BC combination, the B allele is proportionately shared by the AB and the BC contributions to the DNA mixture. Taking each allele combination in turn we consider first the amount of contribution of the A and C alleles attributable to genotypes AB & BC. The proportion of the A allele in the total mixture contribution is A/(A+C)=500/(500+790)=0.39. The proportion of the C allele in the total mixture contribution is C/(A+C)=790/(500+790)=0.61. Using Rule 2, then, we attribute the level of contribution of the total B allele in the mixture to each genotype (AB) and (BC) proportionately by their individual (homozygous allele) contribution to the mixture as we calculated above. That means that the amount of B allele (heterozygous) contribution attributable to the mixture from the AB genotype is calculated as the proportion of A contribution to the total mixture*the total peak height for the B allele in the total mixture, or simply 0.39*1500=585 (see FIG. 3B). Similarly, the amount of B allele contribution from the CB genotype is calculated as the proportion of C contribution to the total mixture*the total peak height for the B allele in the total mixture, or simply 0.61*1500=915 (see FIG. 3B). Using this calculation and distributing the B allele contributions from the two heterozygous genotypes respectively, we see that the AB peak height (500/585=0.85) is equal to the and the BC peak height ratio (790/915=0.85). Using the method of proportionate allele sharing as disclosed herein, the AB PHr will always equal the BC PHR.

Using the calculations derived from Rule 2 we can determine that the proportion of the AB heterozygous genotype contributing to the mixture is the ratio of the total A allele and B allele attributable to the AB genotype (as calculated above) and the total RFUs in the sample (for the A, B and C alleles respectively). This is simply (500+585)/2,790=0.39. Likewise, we determine the proportion of the BC heterozygous genotype contributing to the mixture is the ratio of the total C allele and B allele attributable to the BC genotype (as calculated above) and the total RFUs in the sample (for the A, B and C alleles respectively). This is simply (790+915)/2,790=0.61.

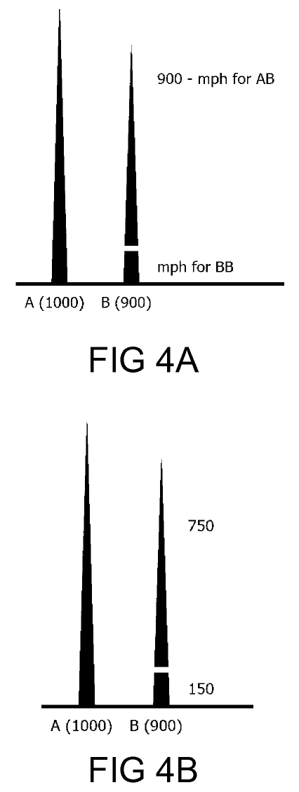

Moving now to Rule 3 and FIG. 4, we see a stylized representation of a electropherogram showing allele peaks corresponding with the A, and B alleles, peak heights being measures in RFUs. The peak heights, as shown in FIG. 4 for alleles A and B are 1000 and 900 respectively.

According to Rule 3, minimum peak heights (mPH) are always maintained and default to 150 RFUs. Referring now to FIG. 4A, for the genotype combination AB & BB, in the case where the difference in peak heights between A and B alleles is less than a predetermined threshold (with a default of 150 RFUs), we assume that the heterozygous allele B contribution from the BB genotype is equal to the minimum peak height (mPH=150). We also assume that the heterozygous allele B contribution from the AB genotype is equal to the difference between the total B allele RFU level and the minimum peak height. Using this assumption, we can calculate the AB pHR as equal to ratio of the heterozygous allele B contribution from the AB genotype (B−mPH) and the total level of A allele in the sample, or simply (B−mPH)/A=(900−150)/1000=0.75.

Using the assumption from Rule 3, we can also calculate the proportion of contribution of the B allele to the sample mixture from the AB genotype as the ratio of the total A in the mixture plus the Rule 3 attributed B allele and the total RFU in the sample, in this case, (1000+750)/1900=0.92.

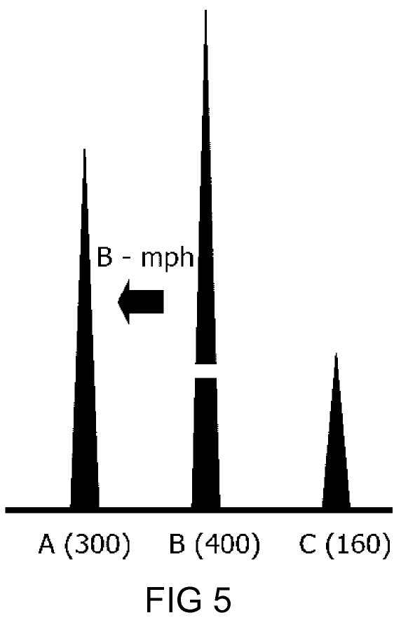

Turning now to the application of Rule 3 to the instance where a mixture has 3 alleles (A, B and C) and to FIG. 5, we see a stylized representation of a electropherogram showing allele peaks corresponding with the A, B and C alleles, peak heights being measures in RFUs. The peak heights, as shown in FIG. 5 for alleles A, B and C are 300, 400 and 160 respectively.

Using Rule 3, we assume that the that the heterozygous allele B contribution from the AB genotype is equal to the difference between the total B allele RFU level and the minimum peak height. Doing so allows us to calculate the AB pHR=(400−150)/300=0.83 and the AB p=(300+250)/t=0.64.

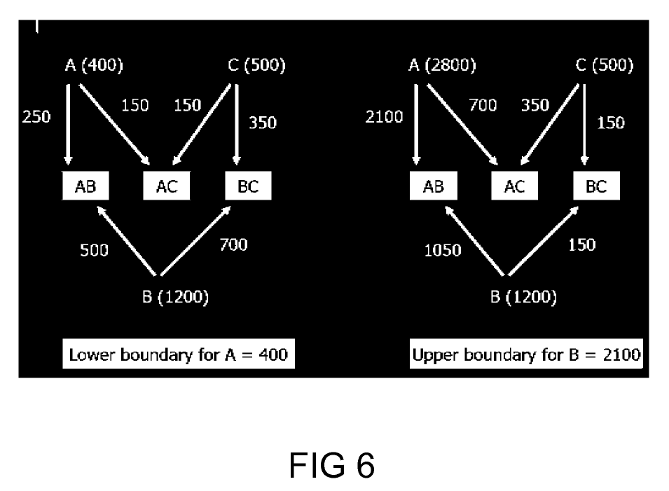

As will be discussed infra, upper and lower boundaries may be calculated in the instance of three-person contributions to preclude combinations that will not allow us to invoke the Rule 1 assumption that all peak height ratios equate to 1. This will be the case where, for example, the AB, and AC genotypes are the major contributors of the B and C alleles and a BC genotype is a minor contributor and vice versa. In such cases, the preferred method allows for upper and lower boundary conditions to be imposed on an individual allele (in this case, A) see FIG. 6. Using this method, possible allele combinations will be determined and presented—even if actual ratios and proportions cannot be determined.

### Mathematics of the Preferred Method of Deconvolution

For Alleles (RFUs): A (a), B(b) . . .

t=the sum of (RFUS)=a+b+ . . .

rAB=the calculated peak height ratio for AB=minimum(a/b, b/a)

pAB=the calculated proportion of AB RFUs to total RFUs=(a+b)/t

AforAB is the calculated portion of a in AB.

AmininAB is the minimum a can be in AB.

AmaxinAB is the maximum a can be in AB.

mPH (mph) is the user defined minimum peak height used in calculations, the default value is 150. Although not specified in the examples below, the mPH is required in every genotype where an allele appears. If there are three contributors with genotypes AA, AB, BC then—

2*mPH total RFUs are required for a (in AA and AB);

2*mPH total RFUs are required for b (in AB and BC); and,

mPH total RFUs are required for c (in BC).

PHr (phr) is the user defined minimum peak height ratio used in calculations, the default value is 0.5.

mP(p) is user defined minimum proportion, the default=0

For most combinations peak height ratios and contributor proportions can be calculated; in two instances (AA and AA; AA, AA, and AA) no calculations are performed; in one instance (AA, AA and AB) only a lower boundary is calculated; in three instances (AA, AB and BC; AB, AC and BC; AB, AC and BD) both upper and lower boundaries are calculated.

When using the 2 or 3 Contributor Mixture Interpretation Method, possible combinations are grouped by category of heterozygote and/or homozygote combinations. For ABCD alleles:

If there are 2 contributors in the mixture, there is one category: AB & CD (with possible combinations: AB & CD, AC & BD, AD & BC);

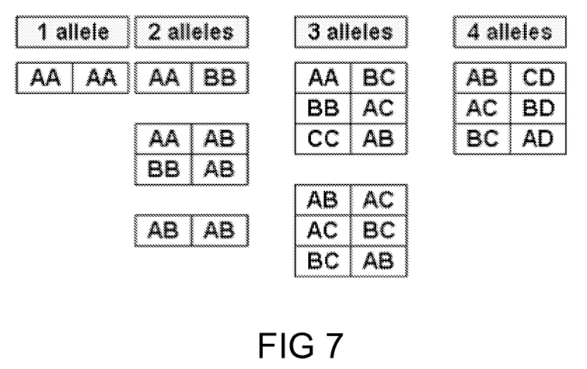

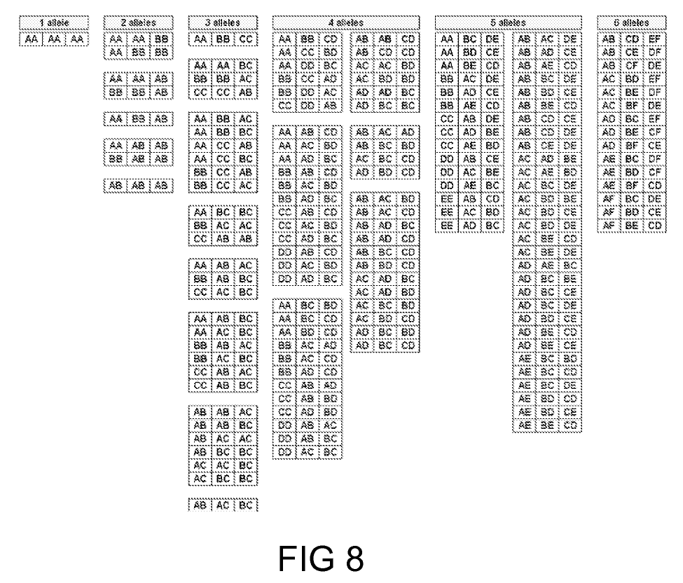

If there are 3 contributors in the mixture, there are 6 categories: AA, BB & CD; AA, AB & CD; AA, BC & BD; AB, AB & CD; AB, AC & AD; AB, AC & BD (with many possible combinations) For a chart of possible contributor contributions see FIGS. 7 and 8.

Peak height ratios and proportions, or upper-lower boundaries (if/when applicable), are always performed on the entire array of possible combinations within each category.

The user may select and set up to six reference samples. When the references are applied, the view of combinations is limited to only those combinations which include the applied references.

The view of combinations is also limited by:

The user-adjustable required PHr (peak height ratio) in calculations.

The user-adjustable required mPH (minimum peak height) in calculations.

The user-adjustable required mP (minimum contributor proportion) in calculations.

Combinations can be calculated:

For two or three contributors.

For a limited selection of the total alleles at a locus (the user may consider one or more alleles extraneous to the calculation).

For maximum stutter or a user-adjustable 10 to 100% of the maximum stutter.

Calculations can be used to generate:

A profile summary.

A graph of contributor contribution proportions.

When evaluating for 2 contributors, AB & CD calculations are a generic category wherein all combinations within such category (AB|CD; AC|BD; AD|BC) are always calculated, with only those calculations falling within established parameters being displayed.

When evaluating for 3 contributors:

6 possibilities for the generic category AA, BB & CD are calculated;

12 possibilities for the generic category AA, AB & CD are calculated;

12 possibilities for the generic category AA, BC & BD are calculated;

6 possibilities for the generic category AB, AB & CD are calculated;

4 possibilities for the generic category AB, AC & AD are calculated; and,

12 possibilities for the generic category AB, AC & BD are calculated.

### Calculations in General Use in the Forensic Community

### Example 1

AA and AA: No peak height ratio or proportion calculations are performed.

### Example 2

AA, AA and AA: No peak height ratio or proportion calculations are performed.

### Example 3

AA and BB: A (500), B (800)

t=a+b=500+800=1300

pAA=a/t=500/1300=0.38

pBB=b/t=0.62

### Example 4

AB and AB: A (500), B (800)

rAB=minimum(a/b, b/a)=minimum(500/800, 800/500)=0.63

### Example 5

AA, AA and BB: A (500), B (800)

t=a+b=500+800=1300

pAA=a/t=500/1300=0.38

pBB=b/t=0.62

### Example 6

AB, AB and AB: A (500), B (800)

rAB=minimum(a/b, b/a) rAB=minimum(500/800, 800/500)=0.63

### Example 7

AA and BC: A (500), B (800), C (900)

t=a+b+c=500+800+900=2200

pAA=a/t=500/2200=0.23

pBC=(b+c)/t=(800+900)/2200=0.77

rBC=minimum(b/c, c/b)=minimum(800/900, 900/800)=0.89

### Example 8

AA, BB and CC: A(2200), B(400), C (500)

t=a+b+c=2200+400+500=3100

pAA=a/t=2200/3100=0.71

pBB=b/t=400/3100=0.13

pCC=c/t=500/3100=0.16

### Example 9

AA, AA and BC: A(2200), B(400), C (500)

t=a+b+c=2200+400+500=3100

pAA=a/t=2200/3100=0.71

pBC=(b+c)/t=(400+500)/3100=0.29

rBC=minimum(b/c, c/b)=minimum(400/500, 500/400)=0.8

### Example 10

AA, BC and BC: A (500), B (800), C (900)

t=a+b+c=500+800+900=2200

pAA=a/t=500/2200=0.23

pBC=(b+c)/t=(800+900)/2200=0.77

rBC=minimum(b/c, c/b)=minimum(800/900, 900, 800)=0.89

### Example 11

AB and CD: A (1000), B (1200), C (2000), D (2100)

t=a+b+c+d=1000+1200+2000+2100=6300

pAB=(a+b)/t=(1000+1200)/6300=0.35

pCD=(c+d)/t=(2000+2100)/6300=0.65

rAB=minimum(a/b, b/a)=minimum(1000/1200, 1200/1000)=minimum(0.83, 1.2)=0.83

rCD=minimum(c/d, d/c)=minimum(2000/2100, 2100/2000)=minimum(0.95, 1.05)=0.95

### Example 12

AA, BB and CD: A(500), B(600), C(700), D (800)

t=a+b+c+d=500+600+700+800=2600

pAA=a/t=500/2600=0.19

pBB=b/t=600/2600=0.23

pCD=(c+d)/t=(700+800)/t=0.58

rCD=minimum(c/d, d/c)=minimum(700/800, 800/700)=0.88

### Example 13

AB, AB and CD: A (1000), B (1200), C (2000), D (2100)

t=a+b+c+d=1000+1200+2000+2100=6300

pAB=(a+b)/t=(1000+1200)/6300=0.35

pCD=(c+d)/t=(2000+2100)/6300=0.65

rAB=minimum(a/b, b/a)=minimum(1000/1200, 1200/1000)=minimum(0.83, 1.2)=0.83

rCD=minimum(c/d, d/c)=minimum(2000/2100, 2100/2000)=minimum(0.95, 1.05)=0.95

### Example 14

AA, BC and DE: A(2200), B(400), C (500), D(900), E(1000)

t=a+b+c+d+e=2200+400+500+900+1000=5000

pAA=a/t=(2200/5000)=0.44

pBC=(b+c)/t=(400+500)/5000=0.18

pDE=(d+e)/t=(900+1000)/5000=0.38

rBC=minimum(b/c, c/b)=minimum(400/500, 500/400)=0.80

rDE=minimum(d/e, e/d)=minimum(900/1000, 1000/900)=0.90

### Example 15

AB, CD and EF: A (600), B (700), C (800), D (900), E (1000), F (1100)

t=a+b+c+d+e+f==600+700+800+900+1000+1100=5100

pAB=(a+b)/t=(600+700)/5100=0.25

pCD=(c+d)/t=(800+900)/5100=0.33

pEF=(e+f)/t=(1000+1100)/5100=0.41

rAB=minimum(a/b, b/a)=(minimum(600/700, 700/600)=0.86

rCD=minimum(c/d, d/c)=minimum(800/900, 900/800)=0.89

rEF=minimum(e/f, f/e)=minimum(1000/1100, 1100/1000)=0.91

### Mixture Interpretation Using Method as Described Herein

Rule 1: Whenever possible (while maintaining mPH, see Rule 3), peak height ratios (PHr) are assumed to equal 1.

### Example 16

If evaluating 2 contributors with genotypes AA & AB, wherein A RFUs−B RFUs≧mPH and assuming a 50% PHr threshold determine how much of the A allele is contributed by the AB genotype:

If 800, then 400/800 means we have a PHr=0.5;

If 200, then 200/400 means we have a PHr=0.5;

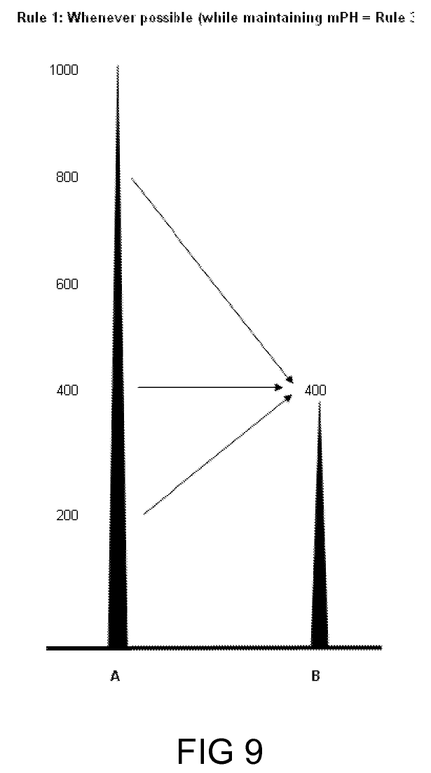

However, if we assume 400, then 400/400 gives a PHr=1; therefore, assume 400 RFUs are contributed by the AB genotype. See FIG. 9

Rule 2: Whenever possible (while maintaining mPH, see Rule 3), shared alleles are shared proportionately.

### Example 17

If evaluating 2 contributors with genotypes AB & BC, wherein RFUs are A(1000), B(1800) and C(600) consider the alleles that will share the C allele:

The percentage of A of A+C=1000/(1000+600)=0.625

The percentage of C of A+C=600/(1000+600)=0.375

Add a B allele and evaluate AB & BC, ensuring that the B allele is proportionately shared:

The amount of B for the AB=1000/(1000+600)*1800=1125

The AB PHr=1000/1125=0.89

The AB p=(1000+1125)/(1000+1800+600)=0.625

The amount of B for the BC=600/(1000+600)*1800=675

The BC PHr=600/675=0.89

Note that these calculations show proportionate sharing of the B allele (the percentage of A in the A+C mixture=the percentage of AB in the A+B+C mixture=0.625; also the AB PHr=the BC PHr=0.89.

Rule 3: Always maintain mPH

### Example 18

If evaluating 2 contributors with genotypes AA & AB, wherein RFUs are A (1000) and B (950) and the difference between the peak heights is less than the minimum peak height (mPH), the AA (homozyote) peak height is set equal to the mPH (that is, AA=150, the default value).

The AB (heterozygote) peak height ratios is equal to (1000−mPH)/950=0.89.

### Example 19

If evaluating 2 contributors with genotypes AB & BC, wherein RFUs are A (300), B (400) and C (160), first determine whether the C allele can be proportionately shared.

The amount of B for the AB=300/(300+160)*400=261

The amount of B for the BC=160/(300+160)*400=139

The calculated portion (139) is less than the default threshold value for mPH (150), therefore for we set b for the BC equal to the mPH(150) and calculate the remainder contributing portion of the B allele contributed by the AB genotype:

AB=400−mPH=250

This results in:

AB PHr=250/300=0.83, and;

BC PHr=150/160=0.94.

The following examples demonstrate how the general calculations used in the forensics community are modified by the three rules disclosed herein.

### Example 20

AA and AB: A (1000), B (800)

t=a+b=1000+800=1800

If a−b≧mPH(1000−800=200) then:

pAA=(a−b)/t=(1000−800)/1800=0.11

pAB=2b/t=(2*800)/1800=0.89

rAB=1

### Example 21

AA and AB: A (1000), B (950)

t=a+b=1000+950=1950

If a−b<mPH(1000−950=50) then:

pAA=mPH/t=150/950=0.08

pAB=(t−mPH)/t=(1950−mPH)/1950=0.92

rAB=minimum[(a−mPH)/b, b/(a−mPH)]=minimum[(1000−150)/950, 950/(1000−150)]=0.89

### Example 22

AA, AA and AB: A (1000), B (600)

t=a+b=1000+600=1600

If a−b>2*mPH(1000−600=400) then:

pAA=(a−b)/t=(1000−600)/1600=0.25

pAB=2b/t=(2*600)/1600=0.75

rAB=1

### Example 23

AA, AA and AB: A (1000), B (950)

t=a+b=1000+950=1950

If a−b<2*mPH(1000−950=50) then:

pAA=(2*mPH)/t=300/1950=0.15

pAB=(t−2*mPH)/t=(1950−2*mPH)/1950=0.85

rAB=minimum[(a−2*mPH)/b, b/(a−2*mPH)]=minimum[(1000−950)/950, 950/(1000−950)]=0.74

### Example 24

AA, AB and AB: A (1000), B (600)

t=a+b=1000+600=1600

If a−b≧2*mPH(1000−600=400) then:

pAA=(a−b)/t=(1000−600)/1600=0.25

pAB=2b/t=(2*600)/1600=0.75

rAB=1

### Example 25

Example 18b: AA, AB and AB: A (1000), B (950)

t=a+b=1000+950=1950

If a−b<mPH(1000−950=50) then:

pAA=(mPH)/t=150/1950=0.08

pAB=(t−mPH)/t=(1950−mPH)/1950=0.92

rAB=minimum[(a−mPH)/b, b/(a−mPH)]=minimum[(1000−150)/950, 950/(1000−150)]=0.89

### Example 26

AB and BC: A(1000), B(1700), C (1200)

t=a+b+c=1000+1700+1200=3900

BforAB=(a*b)/(a+c)=(1000*1700)/(1000+1200)=773

BforBC=(c*b)/(a+c)=(1200*1700)/(1000+1200)=927

If BforAB<mPH then:

BforAB=mPH

BforBC=b−mPH

Elseif BforBC<mPH then:

BforBC=mPH

BforAB=b−mPH

Endif

rAB=minimum(a/BforAB, BforAB/a)=minimum(1000/773, 773/1000)=0.77

rBC=minimum(c/BforBC, BforBC/c)=minimum(1200/927, 927/1200)=0.77

pAB=(a+BforAB)/t=(1000+773)/3900=0.45

pBC=(c+BforBC)/t=(1200+927)/3900=0.55

### Example 27

AB and BC: A(1000), B(800), C (200)

t=a+b+c=1000+800+200=2000

BforAB=(a*b)/(a+c)=(1000*800)/(1000+200)=667

BforBC=(c*b)/(a+c)=(200*800)/(1000+200)=133

If BforBC<mPH(133<150) then

BforBC=mPH=150

BforAB=b−mPH=800−150=650

Endif

rAB=minimum(1000/BforAB, BforAB/1000)=minimum(1000/650, 650/1000)=0.65

rBC=minimum(200/BforBC, BforBC/200)=minimum(200/150, 150/200)=0.75

pAB=(a+BforAB)/t=(1000+650)/2000=0.82

pBC=(c+BforBC)/t=(200+150)/2000=0.18

### Example 28

AA, BB and AC: A(2200), B(400), C (500)

If a−c≧mPH(2200−500=1700) then

t=a+b+c=2200+400+500=3100

pAA=(a−c)/t=(2200−500)/3100=0.55

pAC=(2*c)/t=(2*500)/3100=0.32

pBB=b/t=400/3100=0.13

rAC=1

### Example 29

AA, BB and AC: A(600), B(400), C (500)

If a−c<mPH(600−500=100) then

t=a+b+c=600+400+500=1500

pAA=mPH/t=150/1500=0.10

pAC=(a+c−mPH)/t=(600+500−150)/1500=0.63

pBB=b/t=400/1500=0.27

rAC=minimum[(a−mPH)/c, c/(a−mPH)]=minimum[(600−150) 500, 500/(600−150)]=0.9

### Example 30

AA, AB and AC: A(2200), B(400), C (500)

If a−(b+c)≧mPH(2200−(400+500)=1300; 1300>150) then

t=a+b+c=2200+400+500=3100

pAA=(a−(b+c))/t=(2200−(400+500))/3100=0.42

pAB=(2*b)/t=(2*400)/3100=0.26

pAC=(2*c)/t=(2*500)/3100=0.32

rAB=1

rAC=1

### Example 31

AA, AB and AC: A(700), B(600), C (500)

If a−(b+c)<mPH(700−(600+500)<150) then

t=a+b+c=700+600+500=1800

pAA=mPH/t=150/1800=0.08

AforAB=(b*(a−mPH))/(b+c)=(600*(700−150))/(600+500)=300

AforAC=(c*(a−mPH))/(b+c)=(500*(700−150))/(600+500)=250

If AforAB<mPH then

AforAB=mPH

AforAC=(a−mPH)−mPH

Endif

If AforAC<mPH then

AforAC=mPH

AforAB=(a−mPH)−mPH

Endif

pAB=(b+AforAB)/t=(600+300)/1800=0.50

pAC=(c+AforAC)/t=(500+250)/1800=0.42

rAB=minimum(AforAB/b, b/AforAB)=minimum(300/600, 600/300)=0.5

rAC=minimum(AforAC/c, c/AforAC)=minimum(250/500, 500/250)=0.5

### Example 32

AB, AB and AC: A (1700), B (1100), C (800)

t=a+b+c=1700+1100+800=3600

AforAB=(a*b)/(b+c)=(1700*1100)/(1100+800)=984

AforAC=(a*c)/(b+c)=(1700*800)/(1100+800)=716

If AforAB<2*mPH then:

AforAB=2*mPH

AforAC=a−2*mPH

Elseif AforAC<mPH then:

AforAC=mPH

AforAB=a−mPH

Endif

rAB=minimum(b/AforAB, AforAB/b)=minimum(1100/984, 984/1100)=0.89

rAC=minimum(c/AforAC, AforAC/c)=minimum(800/716, 716/800)=0.89

pAB=(b+AforAB)/t=(1000+773)3900=0.58

pAC=(c+AforAC)/t=(1200+927)3900=0.42

### Example 33

AB, AB and AC: A (700), B (1100), C (200)

t=a+b+c=700+1100+200=2000

AforAB=(a*b)/(b+c)=(700*1100)/(1100+200)=592

AforAC=(a*c)/(b+c)=(700*200)/(1100+200)=108

If AforAB<2*mPH then

AforAB=2*mPH

AforAC=a−2*mPH

Elseif AforAC<mPH(108<150) then

AforAC=mPH=150

AforAB=a−mPH=700−150=550

Endif

rAB=minimum(b/AforAB, AforAB/b)=minimum(1100/550, 550/1100)=0.50

rAC=minimum(c/AforAC, AforAC/c)=minimum(200/150, 150/200)=0.75

pAB=(b+AforAB)/t=(1100+550)/2000=0.82

pBC=(c+AforAC)/t=(200+150)/2000=0.18

### Example 34

AA, AB and CD: A(2200), B(400), C (500), D(900)

If a−b≧mPH then

t=a+b+c+d=2200+400+500+900=4000

pAA=(a−b)/t=(2200−400)/4000=0.45

pAB=(2*b)/t=(2*400)/4000=0.20

pCD=(c+d)/t=(500+900)/4000=0.35

rAB=1

rCD=minimum(c/d, d/c)=minimum(500/900, 900/500)=0.56

### Example 35

AA, AB and CD: A(500), B(400), C (500), D(900)

If a−b<mPH(500−400<150) then

t=a+b+c+d=500+400+500+900=2300

pAA=mPH/t=150/2300=0.07

pAB=(a+b−mPH)/t=(500+400−150)/2300=0.33

pCD=(c+d)/t=(500+900)/2300=0.61

rAB=minimum[(a−mPH)/b, b/(a−mPH)[=minimum[(500−150) 400, 400/(500−150)]=0.88

rCD=minimum((c/d, d/c)=(500/900, 900/500)=0.56

### Example 36

AA, BC and BD: A(500), B(800), C (400), D(700)

t=a+b+c+d=500+800+400+700=2400

BforBC=(b*c)/(c+d)=(800*400)/(400+700)=291

BforBD=(b*d)/(c+d)=(800*700)/(400+700)=509

pAA=a/t=(500/2400)=0.21

pBC=(c+BforBC)/t=(400+291)/2400=0.29

pBD=(d+BforBD)/t=(700+509)/2400=0.50

rBC=minimum(c/BforBC, BforBC/c)=minimum(400/291, 291/400)=0.73

rBD=minimum(d/BforBD, BforBD/d)=minimum(700/509, 509/700)=0.73

### Example 37

AA, BC and BD: A(500), B(550), C (250), D(700)

t=a+b+c+d=500+550+250+700=2000

BforBC=(b*c)/(c+d)=(550*250)/(250+700)=145

BforBD=(b*d)/(c+d)=(550*700)/(250+700)=405

If BforBC<mPH(145<150) then

BforBC=mPH=150

BforBD=b−mPH=550−150=400

Elseif BforBD<mPH then

BforBD=mPH

BforBC=b−mPH

pAA=a/t=500/2000=0.25

pBC=(c+BforBC)/t=(250+150)/2000=0.20

pBD=(d+BforBD)/t=(700+400)/2000=0.55

rBC=minimum(c/BforBC, BforBC/c)=minimum(250/150, 150/250)=0.6

rBD=minimum(d/BforBD, BforBD/d)=(700/400, 400/700)=0.57

### Example 38

AB, AC and AD: A(2200), B(400), C (500), D(900)

t=a+b+c+d=400+500+900+2200=4000

AforAB=(a*b)/(b+c+d)=(2200*400)/(400+500+900)=489

AforAC=(a*c)/(b+c+d)=(2200*500)/(400+500+900)=611

AforAD=(a*d)/(b+c+d)=(2200*900)/(400+500+900)=1100

rAB=minimum(b/AforAB, AforAB/b)=minimum(400/489, 489/400)=0.82

rAC=minimum(c/AforAC, AforAC/c)=minimum(500/611, 611/500)=0.82

rAD=minimum(d/AforAD, AforAD/d)=minimum(900/1100, 1100/900)=0.82

pAB=(b+AforAB)/t=(400+489) 4000=0.22

pAC=(c+AforAC)/t=(500+611) 4000=0.28

pAD=(d+AforAD)/t=(900+1100)/4000=0.5

### Example 39

AB, AC and AD: A(1300), B(600), C (900), D(170)

t=a+b+c+d=1300+600+900+170=2970

AforAB=(a*b)/(b+c+d)=(1300*600)(600+900+170)=467

AforAC=(a*c)/(b+c+d)=(1300*900)(600+900+170)=701

AforAD=(a*d)/(b+c+d)=(1300*170)(600+900+170)=132

If AforAB<mPH and AforAC>=mPH and AforAD>=mPH then

AforAB=mPH

AforAC=(c/(c+d))*(a−mPH)

AforAD=(d/(c+d))*(a−mPH)

Elseif AforAB>=mPH and AforAC<mPH and AforAD>=mPH then

AforAC=mPH

AforAB=(b/(b+d))*(a−mPH)

AforAD=(d/(b+d))*(a−mPH)

Elseif AforAB>=mPH and AforAC>=mPH and AforAD<mPH then

AforAD=mPH

AforAB=(b/(b+c))*(a−mPH)=(600/(600+900)*(1300−150)=460

AforAC=(c/(b+c))*(a−mPH)=(900/(600+900)*(1300−150)=690

Endif

rAB=minimum(b/AforAB, AforAB/b)=minimum(600/460, 460/600)=0.77

rAC=minimum(c/AforAC, AforAC/c)=minimum(900/690, 690/900)=0.77

rAD=minimum(d/AforAD, AforAD/d)=minimum(170/150, 150/170)=0.88

pAB=(b+AforAB)/t=(600+460)/2970=0.36

pAC=(c+AforAC)/t=(900+690)/2970=0.54

pAD=(d+AforAD)/t=(170+150)/2970=0.11

### Example 40

AB, AC and AD: A(1000), B(170), C (180), D(900)

t=a+b+c+d=1000+170+180+900=2250

AforAB=(a*b)/(b+c+d)=(1000*170)(170+180+900)=136

AforAC=(a*c)/(b+c+d)=(1000*180)/(170+180+900)=144

AforAD=(a*d)/(b+c+d)=(1000*900)/(170+180+900)=720

If AforAB<mPH and AforAC<mPH and AforAD>=mPH then

AforAB=mPH=150

AforAC=mPH=150

AforAD=RFU1−2*mPH=1000−300=700

Elseif AforAB<mPH and AforAC>=mPH and AforAD<mPH then

AforAB=mPH=150

AforAD=mPH=150

AforAC=RFU1−2*mPH=1000−300=700

Elseif AforAB>=mPH and AforAC<mPH and AforAD<mPH then

AforAC=mPH=150

AforAD=mPH=150

AforAB=RFU1−2*mPH=1000−300=700

Endif

rAB=minimum(b/AforAB, AforAB/b)=minimum(170/150, 150/170)=0.88

rAC=minimum(c/AforAC, AforAC/c)=minimum(180/150, 150/180)=0.83

rAD=minimum(d/AforAD, AforAD/d)=minimum(900/700, 700/900)=0.78

pAB=(b+AforAB)/t=(170+150)/2250=0.14

pAC=(c+AforAC)/t=(180+150)/2250=0.15

pAD=(d+AforAD)/t=(900+700)/2250=0.71

### Example 41

AB, CD and CE: A(800), B(900), C (1200), D (800), E (600)

t=a+b+c+d+e=800+900+1200+800+600=4300

CforCD=(c*d)/(d+e)=(1200*800)/(800+600)=686

CforCE=(c*e)/(d+e)=(1200*600)/(800+600)=514

pAB=(a+b)/t=(800+900)/4300=0.40

pCD=(d+CforCD)/t=(800+686)4300=0.35

pCE=(e+CforCE)/t=(600+514)4300=0.26

rAB=minimum(a/b, b/a)=minimum(800/900, 900/800)=0.89

rCD=minimum(d/CforCD, CforCD/d)=minimum(800/686, 686/800)=0.86

rCE=minimum(e/CforCE, CforCE/e)=minimum(600/514, 514/600)=0.86

### Example 42

AB, CD and CE: A(800), B(900), C (800), D(900), E(200)

t=a+b+c+d+e=800+900+800+900+200=3600

CforCD=(c*d)/(d+e)=(800*900)/(900+200)=655

CforCE=(c*e)/(d+e)=(800*200)/(900+200)=145

If CforCD<mPH then

CforCD=mPH

CforCE=c−mPH

Elseif CforCE<mPH(145<150) then

CforCE=mPH=150

CforCD=c−mPH=800−150=650

Endif

pAB=(a+b)/t=(800+900)/3600=0.47

pCD=(d+CforCD)/t=(900+650)3600=0.43

pCE=(e+CforCE)/t=(200+150)3600=0.10

rAB=minimum(a/b, b/a)=minimum(800/900, 900/800)=0.89

rCD=minimum(d/CforCD, CforCD/d)=minimum(900/650, 650/900)=0.72

rCE=minimum(e/CforCE, CforCE/e)=(200/150, 150/200)=0.75

### Determining Upper and Lower Boundaries In Situations where Ratios and Proportions are not Calculated in the Preferred Embodiment

### Example 43

(lower boundary only−not ratios and proportions): AA, BB and AB

The lower boundaries for a and b:

a must be >=2*mPH

b must be >=2*mPH

### Example 44

The lower boundary for b: A (500), B (500), C (700)

The lower boundary for b in AB assumes minimum a in AB; if a is maximized in AA (a−mPH), then:

mPH is the minimum b could be in AB

Since c in BC is constant:

PHr*c is the minimum b could be in BC

Therefore:

b must be >=mPH+PHr*c (150+0.5*700=500)

In this example, BC:

c=700

so b must be at least 350 for rBC=0.5

Check:

if b was <500 then rBC would be <PHr or the b in AB would be <mPH

also:

if c was >700 then the rBC would be <PHr or the b in AB would be <mPH

### Example 45

AA, AB and BC: The upper boundary for b: A (500), B (2100), C (700)

The upper boundary for b in AB assumes maximum a in AB; if a is minimized in AA (mPH), then:

a in AB=a−mPH

(a−mPH)/PHr is the maximum b could be in AB

Since c in BC is constant:

c/PHr is the maximum b could be in BC

Therefore:

b must be <=(a−mPH)/PHr+c/PHr=(500−150)/0.5+700/0.5=2100

In this example, AB:

could have at most 350 of a (since a in AA must be at least mPH)

could have at most 700 of b (since a can not be larger than 350) for rAB=0.5

In this example, BC:

has all of c (700)

could have at most 1400 of b for rBC=0.5

Check:

if b was >2100 then rBC would be <PHr or rAB could be <PHr

also:

if c was <700 then the rBC would be <PHr or the rAB would be <PHr

### Example 46

AB, AC and BC: The lower boundary for a: A (400), B (1200), C (500)

The lower boundary for a in AB assumes minimum b in AB; the lower boundary for a in AC assumes minimum c in AC:

If b>=c and (c−mPH)/(b−mPH)≧PHr then

BmininAB=mPH

CmininAC=mPH

AmininAB=mPH

AmininAC=mPH

Elseif b>c and (c−mPH)/(b−mPH)<PHr then

BmininAB=maximum (mPH, b−(c−mPH)/PHr)

CmininAC=mPH

AmininAB=maximum (mPH, PHr*BmininAB)

AmininAC=mPH

Elseif c>=b and (b−mPH)/(c−mPH)>=PHr then

BmininAB=mPH

CmininAC=mPH

AmininAB=mPH

AmininAC=mPH

Elseif c>b and (b−mPH)/(c−mPH)<PHr then

BmininAB=mPH

CmininAC=maximum (mPH, c−(b−mPH)/PHr)

AmininAB=mPH

AmininAC=maximum (mPH, PHr*CmininAC)

Endif

Therefore:

a must be >=AmininAB+AmininAC

In this example, since b>c and (c−mPH)/(b−mPH)<PHr

1200>500 and (500−150)/(1200−150)<0.5

BmininAB=1200−(500−150)/0.5=500

CmininAC=150

AmininAB=0.5*500=250

AmininAC=150

a must be 250+150=400

Check:

If a was <1300 then rAB would be <PHr or the a in AC would be <mPH

also:

if b>1200 then rAB would be <PHr or rBC would be <PHr

if c<500 then rBC would be <PHr or rAC would be <PHr

### Example 47

AB, AC and BC: The upper boundary for a: A (2800), B (1200), C (500)

The upper boundary for a in AB assumes maximum b in AB; the upper boundary for a in AC assumes maximum c in AC:

mPH is the smallest b could be in BC

(b−mPH)/PHr is the largest a could be in AB

mPH is the smallest c could be in BC

(c−mPH)/PHr is the largest a could be in AC

Therefore:

a must be <=(b−mPH)/PHr+(c−mPH)/PHr

In this example a must be <=(1200−150)/0.5+(500−150)/0.5<=2800

Check:

if a was >2800 then rAB would be <PHr or the rAC would be <PHr

Also:

if b<1200 then rAB would be <PHr or the b in BC would be <mPH

if c<500 then rAC would be <PHr or the rBC would be <PHr

### Example 48

AB, AC and BD: The lower boundary for b: A (500), B (800), C (700), D (1300)

The lower boundary for b in AB assumes minimum a in AB, and maximum a in AC:

If a>c/PHr+mPH then

AmaxinAC=c/PHr

The minimum a in AB=maximum (mPH, a−AmaxinAC)

In this example c/PHr+mPH=700/0.5+150=1550), so this AmaxinAC does not apply.

Elseif a>=PHr*c+mPH then:

AmaxinAC=a−mPH

The minimum a in AB=maximum (mPH, a−AmaxinAC)

In this example AmaxinAC=500−150=350

In this example PHr*c+mPH=(0.5*700+150=500), so this AmaxinAC applies.

Endif

BmininAB=maximum (mPH, PHr*(a−AmaxinAC)=maximum (150, 500−350)=150

BmininBD=maximum (mPH, PHr*d)=maximum (150, 0.5*1300)=650

The lower boundary of b=BmininAB+BmininBD=150+650=800

In this example, BD:

has all d (1300)

must have at least 650 of b for rBD=0.5 (150 of b remains)

In this example, AC:

has all of c (700)

must have at least 350 of a for rAC=0.5 (150 of a remains)

In this example, AB:

has the remaining 150 of a

has the remaining 150 of b

Check:

if b was <800 then the rBD would be <PHr or the b in AB would be <mPH

also:

if d was >1300 then the rBD would be <PHr or the b in AB would be <mPH

if c was >700 then the rAC would be <PHr or the a in AB would be <mPH

if a was <500 then the rAC would be <PHr or the a in AB would be <mpH

### Example 49

AB, AC and BD: The upper boundary for b: A (500), B (2900), C (700), D (1300)

The upper boundary for b in AB assumes maximum a in AB, and minimum a in AC.

Since c is constant in AC:

AmininAC=maximum (mPH, PHr*c)=maximum (150, 0.5*700)=350

BmaxinAB=(a−AminimAC)/PHr=(500−350)/0.5=300

Since d is constant in BD:

BmaxinBD=d/PHr=1300/0.5=2600

Therefore:

b must be <=BmaxinAB+BmaxinBD=300+2600=2900

In this example, BD:

has all d (1300)

could have at most 2600 of b for rBD=0.5 (300 of b remains)

In this example, AC:

has all of c (700)

must have at least 350 of a rAC=0.5 (150 of a remains)

In this example, AB:

has the remaining 150 of a

could have at most 300 of b for rAB=0.5

Check:

if b was >2900 then the rBD would be <PHr or rAB would be <PHr

also:

if d was <1300 then the rBD would be <PHr or the rAB would be <PHr

if c was >700 then the rAC would be <PHr or the a in AB would be <mPH

if a was <500 then the rAC would be <PHr or the a in AB would be <mPH

### Calculating Frequencies in the Preferred Embodiment

### Single Source:

Unrelated Locus (with allele frequencies p, q):

homozygotes: p²+p (1−p)⊖, ⊖=0.01 (default) or 0.03

heterozygotes: 2pq

Unrelated Locus (with allele frequencies p, Any)

heterozygotes: p²+p (1−p)⊖+2p(1−p)

Full siblings Locus (with allele frequencies p, q)

homozygotes: (1+2p+p²)/4

heterozygotes: (1+p+q+2pq)/4

Parents and Offspring Locus (with allele frequencies p, q)

homozygotes: p²+4p(1−p)/4

heterozygotes: 2pq+2(p+q−4pq)/4

Half-Siblings, Uncles and Nephews Locus (with allele frequencies p, q)

homozygotes: p²+4p(1−p)/8

heterozygotes: 2pq+2(p+q−4pq)/8

First Cousins Locus (with allele frequencies p, q)

homozygotes: p²+4p(1−p)/16

heterozygotes: 2pq+2(p+q−4pq)/16

Overall frequency=

(Locus 1)(Locus 2) . . . (Locus n)

### 2-Contributors Mixtures:

Locus (with allele frequencies p, q)

the sum of all applicable homozygotes and heterozygotes

homozygotes: p²+p(1−p)⊖, ⊖=0.01 (default) or 0.03

heterozygotes: 2pq

or for Any single allele+any allele

Any=p²+p(1−p)⊖+2p(1−p)

p²+p(1−p)⊖ for the homozygote possibility

2p(1−p) for all heterozygote possibilities

Overall frequency=

(Locus 1)(Locus 2) . . . (Locus n)

### Calculating PE Probability of Inclusion, PE Probability of Exclusion in the Preferred Embodiment

Locus (with allele frequencies a, b . . . n)

P=sum(a+b+ . . . +n)

Q=1−P

PE=Q²+2PQ

PI=1−PE

Overall frequency=

(Locus 1)(Locus 2) . . . (Locus n)

### Calculating the Likelihood Ratio in the Preferred Embodiment

Profiles with one allele a

Allele a from x unknown contributors

Pₓ(a|a)=pₐ^{2x}

If knowns contribute a to the profile

Pₓ(φ|a)=pₐ^{2x}

Profiles with two alleles a, b

Allele a from x unknown contributors (b is from a known contributor)

Pₓ(a|ab)=(pₐ+p_{b})^{2x}−p_{b}^{2x}

For no known contributors

Pₓ(ab|ab)=(pₐ+p_{b})^{2x}−pₐ^{2x}−p_{b}^{2x}

If knowns contribute a, b to the profile

Pₓ(φ|ab)=(pₐ+p_{b})^{2x}

Profiles with three alleles a, b, c

Allele a from x unknown contributors (b, c are from a known contributor)

Pₓ(a|abc)=(pₐ+p_{b}+p_{c})^{2x}−(p_{b}+p_{c})^{2x}

Alleles a, b from x unknown contributors (c is from a known contributor)

Pₓ(ab|abc)=(pₐ+p_{b}+p_{c})^{2x}−(pₐ+p_{b})^{2x}−(pₐ+p_{c})^{2x}+p_{c}^{2x}

Alleles a, b, c from x unknown contributors

Pₓ(abc|abc)=(pₐ+p_{b}+p_{c})^{2x}−(pₐ+p_{b})^{2x}−(p_{b}+p_{c})^{2x}−(pₐ+p_{c})^{2x}+pₐ^{2x}+p_{b}^{2x}+p_{c}^{2x}

If knowns contribute a, b, c to the profile

Pₓ(φ|abc)=(pₐ+p_{b}+p_{c})^{2x}

Profiles with four alleles a, b, c, d

Allele a from x unknown contributors (b, c, d are from known contributors)

Pₓ(a|abcd)=(pₐ+p_{b}+p_{c}+p_{d})^{2x}−(p_{b}+p_{c}+p_{d})^{2x}

Alleles a, b from x unknown contributors (c, d are from a known contributor)

Pₓ(ab|abcd)=(pₐ+p_{b}+p_{c}+p_{d})^{2x}−(p_{b}+p_{c}+p_{d})^{2x}−(pₐ+p_{c}+p_{d})^{2x}+(p_{c}+p_{d})^{2x}

Alleles a, b, c from x unknown contributors (d is from a known contributor) (x>1)

Pₓ(abc|abcd)=(pₐ+p_{b}+p_{c}+p_{d})^{2x}−(p_{b}+p_{c}+p_{d})^{2x}−(pₐ+p_{c}+p_{d})^{2x}−(pₐ+p_{b}+p_{d})^{2x}+(p_{c}+p_{d})^{2x}+(p_{b}+p_{d})^{2x}+(pₐ+p_{d})^{2x}−p_{d}^{2x}

Alleles a, b, c, d from x unknown contributors (x>1)

Pₓ(abcd|abcd)=(pₐ+p_{b}+p_{c}+p_{d})^{2x}−(p_{b}+p_{c}+p_{d})^{2x}−(pₐ+p_{c}+p_{d})^{2x}−(pₐ+p_{b}+p_{d})^{2x}−(pₐ+p_{b}+p_{c})^{2x}+(p_{c}+p_{d})^{2x}+(p_{b}+p_{d})^{2x}+(p_{b}+p_{c})^{2x}+(pₐ+p_{d})^{2x}+(pₐ+p_{c})^{2x}+(pₐ+p_{b})^{2x}−pₐ^{2x}−p_{b}^{2x}−p_{c}^{2x}−p_{d}^{2x}

If knowns contribute a, b, c, d to the profile

Pₓ(φ|abcd)=(pₐ+p_{b}+p_{c}+p_{d})^{2x}

### Identifying Individuals

The preferred system and method embodiments of this invention are useful for identifying individuals from mixed stains. This has application, for example, in individual identity, where DNAs (e.g., from people, children, accident victims, crime victims, perpetrators, medical patients, animals, plants, other living things with DNA) may be mixed together into a single mixed sample. Then, mixture deconvolution can resolve the mixed data into its component parts. This can be done with the aid of reference individuals, though it is not required.

Unique identification of individual components of mixed DNA samples is useful for finding suspects from DNA evidence, and for identifying individuals from DNA data in forensic and nonforensic situations. An individual's genotype can be matched against a database for definitive identification. This database might include evidence, victims, suspects, other individuals in relevant cases, law enforcement personnel, or other individuals (e.g., known offenders) who might be possible candidates for matching the genotype. In one preferred embodiment, the database is a state, national or international DNA database of convicted offenders.

When there are no (or only some) reference individuals, but other information (such as a database of profiles of candidate component genotypes) is available, then the invention can similarly derive such genotypes and statistical confidences from the DNA mixture data. This is useful in finding suspect individuals who might be on such a database, and has particular application to finding persons (e.g., criminals, missing persons) who might be on such a database.

When there is little or no supplementary information, the disclosed method permits computation of probabilities, and evaluation of hypotheses. For example, a likelihood ratio can compare the likelihood of the data under two different models.

### Convict Criminals

DNA mixtures are currently analyzed by human inspection of qualitative data (e.g., electrophoretic bands are present, absent, or something in between). Moreover, they are recorded on databases and reported in court in a similarly qualitative way, using descriptors such as “major” or “minor” band, and “the suspect cannot be excluded” from the mixture. Such statements are not optimally compelling in court, and lead to crude database searches generating multiple hits.

The system and methods of the preferred embodiment of the invention allow for precise and accurate quantitative analysis of the mixture data to reveal unique identities in many cases. Moreover, these mixture analyses can be backed up by statistical certainties that are useful in convincing presentation of evidence. The increased certainty of identification is reflected in the increased likelihood ratios, as well as other probabilities and statistics, as described above.

As discussed, with the random person hypothesis of the defense, the current conservative LR analysis weighs heavily in favor of the defense (National Research Council, Evaluation of Forensic DNA Evidence: Update on Evaluating DNA Evidence, 1996, Washington, D.C.: National Academy Press), incorporated by reference. The system and analysis disclosed herein help standardize the assumptions made, reduce the potential for examiner error and simplifies the presentation of the evidence, reducing the amount of mathematics that must be explain to the lay juror.

The invention includes using quantitative data. This may entail proper analysis or active preservation of the raw STR data, including the gel or capillary electrophoresis data files. Removing or destroying this highly quantitative information can lead to suboptimal data analysis or lost criminal convictions. The invention enables mathematical estimation of genotypes, together with statistical certainties, that overcome the qualitative limitations of the current art, and can lead to greater certainty in human identification with increased likelihood of conviction in problematic cases.

### Generate Reports

Preparing and reviewing reports on mixed DNA samples is tedious and time consuming work for the forensic analyst. This DNA analysis and reporting expertise is also quite expensive, and represents the single greatest cost in crime laboratory DNA analysis. It would be useful to automate this work, including the report generation. This automation has the advantages of higher speed, more rapid turnaround, uniformly high quality, reduced expense, eliminating casework backlogs, alleviating tedium, and objectivity in both analysis and reporting.

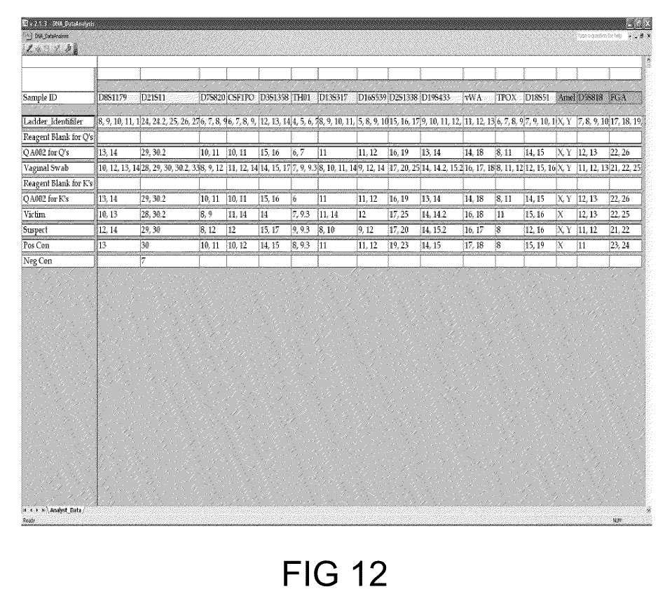

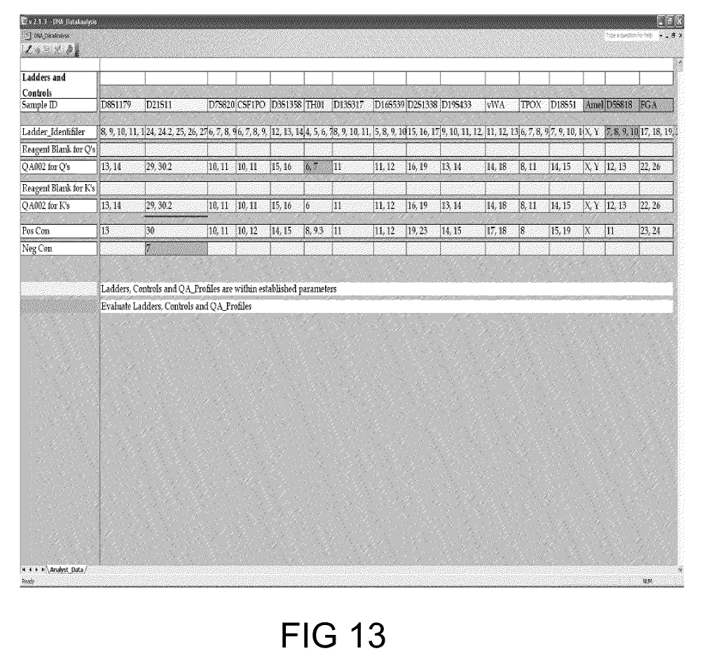

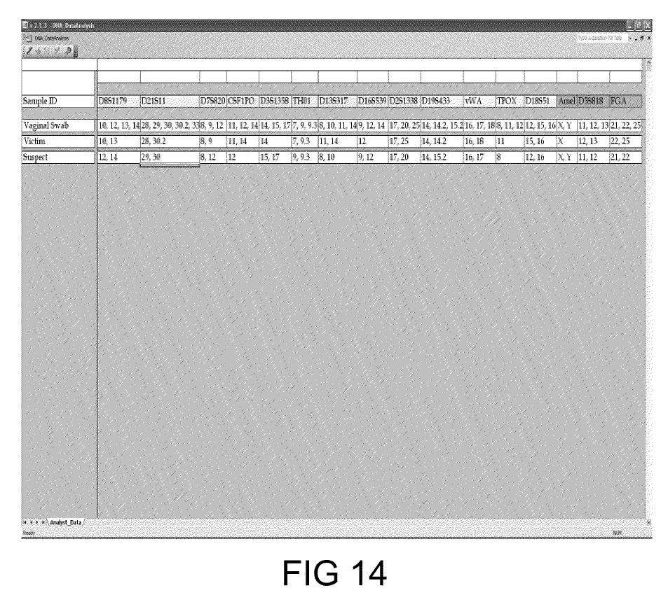

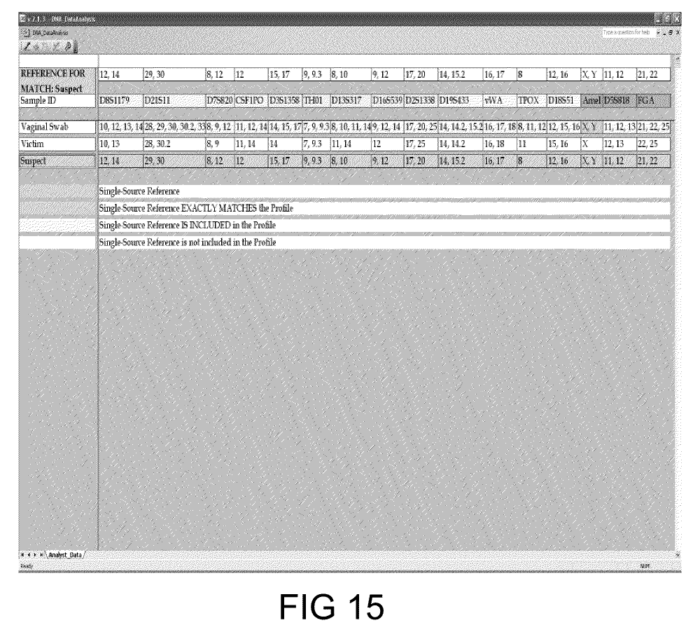

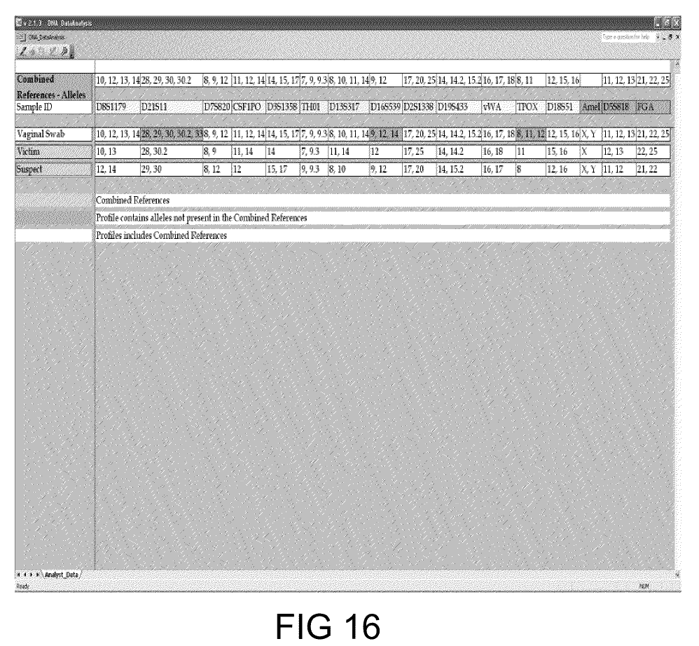

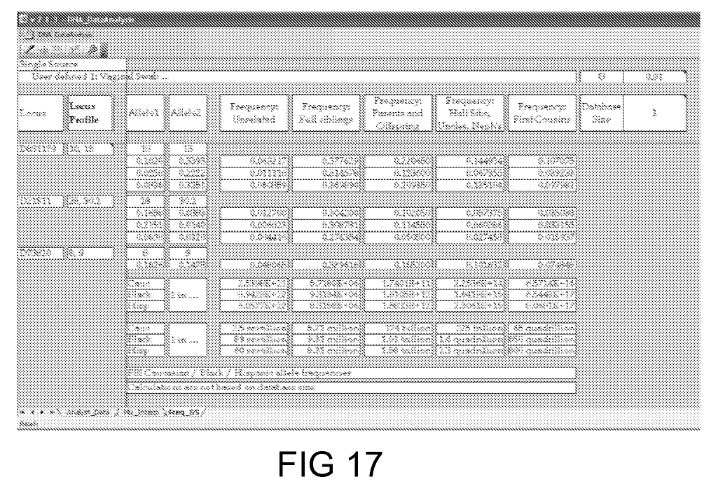

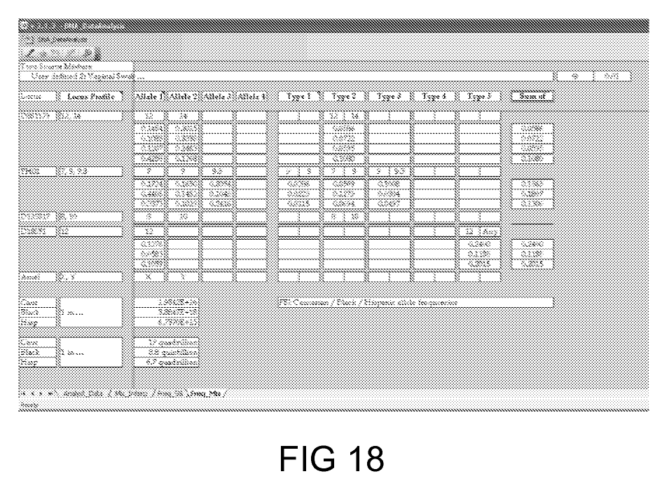

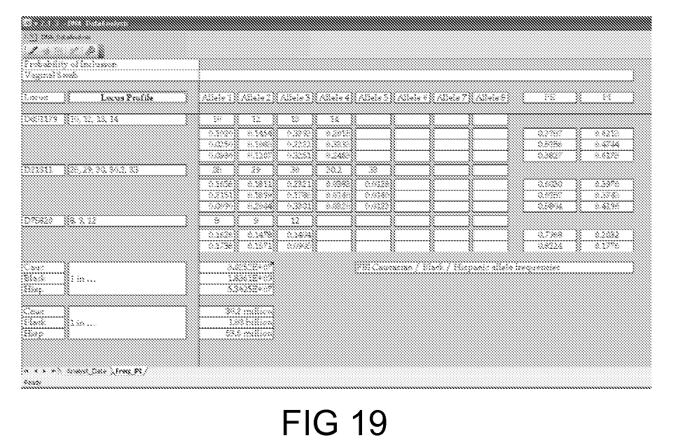

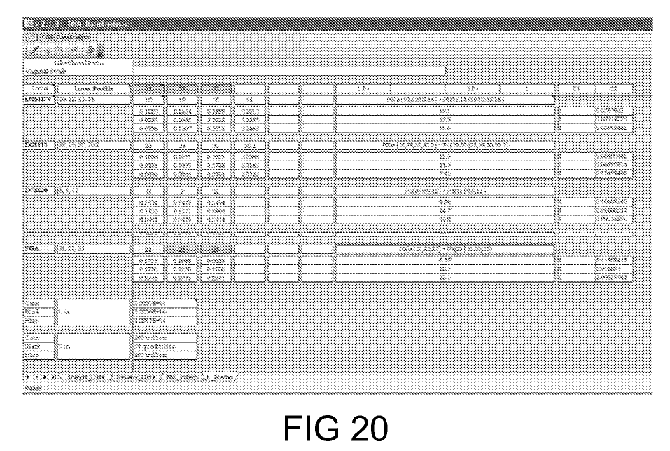

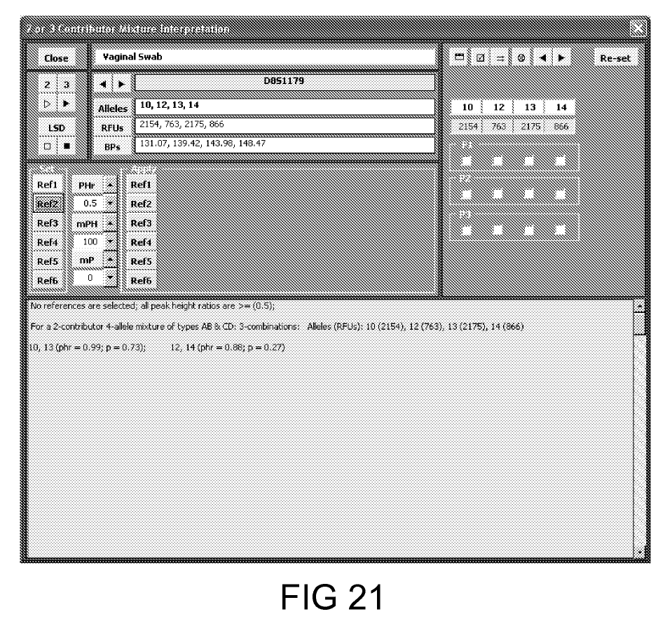

The system and method of the preferred embodiment are designed for computer-based automation of DNA analysis. The results are computed mathematically, and then can be presented automatically as tables and figures via a user interface to the forensic analyst (see FIGS. 12-21). This analysis and presentation automation provides a mechanism for automated report generation.

There is a basic template for reporting DNA evidence with which information and analyses that are unique to the case may be merged with information that is generally included. In one preferred embodiment, a template is developed that provides for references to other files and variables. Preferable formats include readable documents (e.g., word processors, RTF, CSV, XLM, XLMT), hypertext (e.g., HTML), and other portable document formats (e.g., PDF). A template is a complete document that describes the text and graphics for a standard report, either directly or by reference to variables and files.

After the automated mixture analysis, possibly including human review and editing, the computer generates all variables, text, table, figures, diagrams and other presentation materials related to the DNA analysis, and preserves them in files (named according to an agreed upon convention). The template report document refers to these files, using the agreed upon file naming convention, so that these case-specific materials are included in the appropriate locations in the document. The document preparation program is then run to create a document that includes both the general background and case specific information. This report document, including the case related analysis information (possibly including tables and figures), is then preferably output as a bookmarked PDF file. The resulting PDF case report can be electronically stored and transferred, viewed and searched cross platform on local computers or via a network (LAN or WAN), printed, and rapidly provided (e.g., via email) to a crime laboratory or attorney for use as documented evidence.

### Clean Up DNA Databases

Many DNA databases permit the inclusion of qualitatively analyzed mixed DNA samples. This is particularly true of the “forensic” or “investigative lead” database components, that contain evidence from unsolved crimes that can be used for matching against DNA profiles.

When these mixed DNA samples are matched against individual or mixed DNA queries, many items (rather than a unique one) can match. Instead of a single DNA query uniquely matching a single DNA database entry, the DNA query can degenerately match a multiplicity of mixed DNA database entries. This degeneracy is only compounded when mixed DNA queries are made. Mixture degeneracy corrupts the database, replacing highly informative unique query matches with large uninformative lists. In these large lists, virtually all the entries are unrelated to the DNA query.

To prevent this database corruption with mixed DNA profiles, it would be useful to clean up the entries prior to their inclusion on the database. When the raw (or other quantitative) STR data are available, this clean up is readily implemented by the mixture deconvolution invention. For example, consider the common case of a two person mixture containing a known victim and an unknown perpetrator. Mixture deconvolution estimates the genotype of the unknown perpetrator, along with a confidence. (Lower confidences may suggest intelligently using degenerate alleles at some loci.) The resolved unknown perpetrator genotypes are then entered into the forensic database, rather than the usual qualitative (e.g., major and minor peak) multiplicity of degenerate alleles. The result is far more uniqueness in subsequent DNA query matches, with an associated increase in the informativeness and utility of the matches.

### Clean Up DNA Queries

When performing DNA matches against a DNA database, current practice uses mixed DNA stains with degenerate alleles. This practice produces degenerate matches, returning lists of candidate matches, rather than a unique match. Most (if not all) of the entries on this list are typically spurious. The length of these spuriously matching lists grows as the size of the DNA database increases.

With mixture deconvolution system and method disclosed, the genotype b of an unknown contributor can often be uniquely recovered from the data d and the victim(s) a, along with statistical confidence measures. Thus, using the resolved mixture b, instead of the qualitative unresolved data d, a unique appropriate database match can be obtained. Moreover, the result of this match is highly useful, since it removes the inherent ambiguity of degenerate database matching, and largely eliminates spurious matches.

### Reduce Investigative Work

The actual investigative work involved in using the DNA evidence to follow leads is very costly as it is so manpower intensive. One reason why this cost is so high is the large number of leads generated by degenerate matches. Following one lead is expensive; following dozens can be prohibitive. And as the sizes of the DNA databases increase, the investigative cost of degenerate matches (from mixed crime stains or mixed database entries) will increase further.

The mixture deconvolution invention overcomes this developing bottleneck. By cleaning up the information prior to its use, the databasee searching results become more unique and less degenerate. This relative uniqueness translates into reduced investigative work, and greatly reduced costs to society for putting DNA technology into practice.

### Reduce Laboratory Work

In sexual assault cases, differential DNA extraction is conducted on semen stains in order to isolate the semen as best as possible. This is done because, a priori, semen stains are considered to be mixed DNA samples, and the best possible (i.e., unmixed) evidence is required for finding and convicting the assailant. Thus, mixture separation is attempted by laboratory separation processes. The full differential extraction protocols for isolating sperm DNA are laborious, time consuming, and expensive. They entail differential cell lysis, and repeatedly performing Proteinase K digestions, centrifugations, organic extractions, and incubations; these steps are followed by purification (e.g., using micro concentration). There are also Chelex-based methods. These procedures consume much (if not most) of the laboratory effort and time (often measured in days) required to for laboratory analysis of the DNA sample. This time factor contributes to the backlog and delay in processing rape kits.

Modified differential DNA extraction procedures are also utilized. These procedures eliminate most of the repetitious Proteinase K digestions, organic solvent separations, and centrifugations, reducing the total extraction effort from days to hours. However, they do not provide the same degree of separation of the sperm DNA template as does the costlier full differential extraction. In fact, highly mixed DNA samples will often result.

With the mixture deconvolution system and method preferred embodiment, it feasible to expedite the process. The result is the same: the assailant's sperm cells genotype b is separated from the victim's epithelial genotype a using the mixed data d. The invention enables crime labs to use faster, simpler and less expensive DNA extraction methods, with an order of magnitude difference. The computer performs the refined DNA analysis, instead of the lab, resolving the mixture into its component genotypes.

### Low Copy Number

To obtain low copy number (LCN) data, laboratories will change the PCR protocol, e.g., increase the cycle number (say, from 28 to 34 cycles with SGMplus). Experiments are often done in duplicate. The combination of less template and more cycles can lead to increased data artifacts. Most prevalent are PCR stutter, allelic dropout, low signal to noise, and mixture contamination. The automated analysis methods described earlier herein readily remove PCR artifacts such as stutter and signal noise.

### Other Formats

The invention is not dependent on any particular arrangement of the experimental data. In the DNA amplification, same DNA template is used throughout. For efficiency and consistency of the amplification conditions, a multiplex reaction is preferred. There is no requirement on the specific label or detector used.

There is no restriction on the dimensionality of the laboratory system. It can accommodate dimensions of zero (tubes, wells, dots), one (gels, capillaries, mass spectrometry), two (gels, arrays, DNA chips), or higher. There is no restriction on the markers or the marker assay used.

### Medicine and Agriculture

There are many settings in biology, medicine, and agriculture where mixed DNA (or RNA) samples occur. These samples can be mixed intentionally, or unintentionally, but the problem remains of determining one or more genotype components.

In biology, for example, when sequencing DNA, it is useful to first sequence the two chromosome sample and then somehow determine the component DNA sequences, rather than subclone to first separate and then sequence them. As described herein, the system and method of the preferred embodiment can deconvolve mixed sequences of discrete information, such as DNA sequences. In HLA typing, for example, the known combinations of sequences permit quantitative information to be resolved using mixture deconvolution.

In medicine, cancer cells are a naturally occurring form of DNA mixtures. In tumors that exhibit microsatellite instability (e.g., from increased STR mutation) or loss of heterozygosity (e.g., from chromosomal alterations), a different typable DNA (the tumor) is mixed in with the normal tissue. By determining the precise amount of the individual's normal DNA, versus the amount of any other DNA (e.g., a diverse tumor population), cancer patients can be diagnosed and monitored using mixture deconvolution. This is done by using the many alleles possibly present at a locus. With diverse tumor tissue subtypes, there may be many alleles present. Quantitative data are collected for d, the individual's known alleles are then used as reference a, and the pattern of the tumor contribution b is determined statistically.

Another application of the system and method of the present invention is in the deconvolution of biopsies preformed at hospitals and medical facilities. It is often the case that a medical laboratory will perform testing on a number of samples from multiple individuals. The reports that are generated by these medical laboratories may be challenged by the end-user (i.e. the physician or, more likely, the patient) as being cross-contaminated with biological material from other sources. Using the various methods and systems of the present invention, it is possible to test the underlying biological material used to generate the report to determine whether there has, indeed, been sample convolution. If this proves to be the case, the invention will allow for the deconvolution of the sample to determine which patients have been analyzed.

In agriculture, animal materials can be mixed, e.g., in food, plant or livestock products. The system and method of the preferred embodiment can deconvolve mixed samples into their individual components.

### Business Model

In a first preferred embodiment, crime or service laboratories generate their own data from DNA samples. The data quantitation and mixture analysis is then done at their site, or, preferably (from a quality control standpoint) at a separate data service center (DSC). This DSC can be operated by a private for-profit entity, or by a centralized government agency. The case is analyzed, and a report then generated (in whole or part) using the software. The report is provided to the originating laboratory. Usage fees are applied on a per case basis, with surcharges for additional work. The DSC may provide quality assurance services for provider laboratories to ensure that the data is analyzable by quantitative methods.

In a second preferred embodiment, the DSC generates the data, and analyzes it as well. This has the advantage of ensured quality control on the data generation. This can be important when the objective is quantitative data that reflects the output of properly executed data generation. After data analysis, the customer receives the report, and is billed for the case.

There are several feasible customers for database work. When entering mixed samples onto a database, it is the database curators and owners (e.g., a centralized government related entity) that is most concerned about the quality of the entered data for future long-term forensic use. This suggests a usage-based contract with said entity for cleaning up the data. A value added by the invention is the capability of finding criminals at a lower cost.

When analyzing a mixed DNA sample, law enforcement agencies (e.g., prosecutors, police, crime labs) may be interested in identifying genotypes in the mixed sample which are unknown, preferably to match them against a database of possible suspects. In this case, a value added by the invention is the reduced cost, time, and effort of mixture analysis and report generation. There is additional value added in obtaining a higher quality result that can more effectively serve the law enforcement needs of the agency.

When matching against a DNA database, a single correct match will lead to minimal and successful investigative work by the police or other parties. Having a multiplicity of largely incorrect matches creates far greater work, for far less benefit. That is the current art. The invention can (in many cases) reduce this work by over an order of magnitude. The value added in this case is the savings in cost and time in the pursuit of justice.

When using mixed DNA evidence in court, the goal is to obtain a conviction or exoneration, depending on the evidence. The current art produces imprecise, qualitative results that are ill-suited to this purpose. Current assessments often vastly understate the true weight of the evidence. The value added in this situation is the capability of the technology to convict the guilty (and keep them off the street) and to exonerate the innocent (and return them to society). The financial model in this case preferably accounts for the benefit to society of appropriately reduced crime and increased productivity.

### System

Some embodiments of this invention include a system for resolving a DNA mixture comprising: (a) means for amplifying a DNA mixture, said means producing amplified products; (b) means for detecting the amplified products, said means in communication with the amplified products, and producing signals; (c) means for quantifying the signals that includes a computing device with memory, said means in communication with the signals, and producing DNA length and concentration estimates; (d) means for automatically resolving a DNA mixture into one or more component genotypes, said means in communication with the estimates; and (e) means for analyzing said estimates and resolutions.

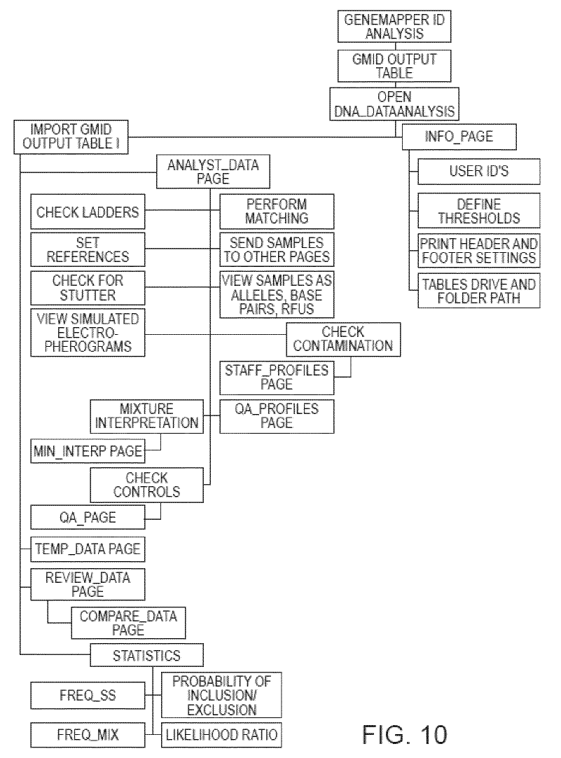

FIG. 10 is a flow diagram of a system embodiment of the invention. The advantages of the present invention over the prior are apparent from diagram including, by way of non-limiting example, QA/QC modules for checking ladders, comparing against known references, checking for stutter, checking controls and checking for contamination with cross-references to staff genetic profiles. The novel mixture interpretation method described herein is also incorporated as a module in this system. Also included in this system embodiment of the invention are statistical modules for calculating, by way of non-limiting example, single source frequencies, probability of inclusion/exclusion, frequency in mixed samples and likelihood ratios according to the methods disclosed herein.

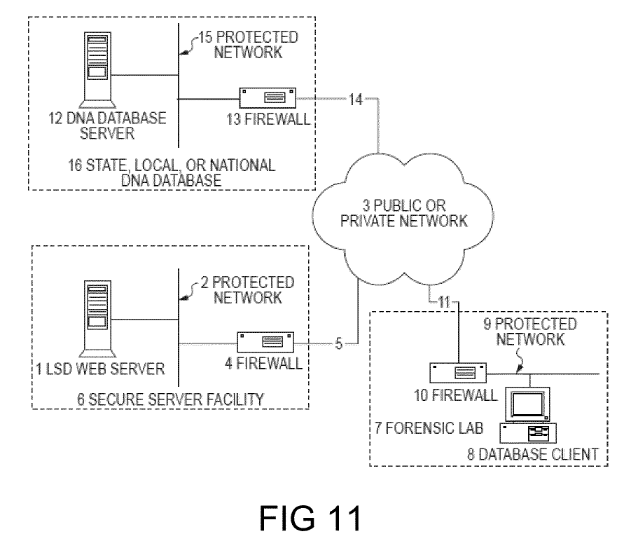

A preferred system embodiment of the invention is shown in FIG. 11. In this embodiment, the method of this invention is implemented using software running under a secure web server 1 on a protected network 2 that is isolated from a public or private network 3 by a firewall 4. A remote user located at a Database Client station 8 may access the implementing software at the web server 1 via the public or private network. The communication may be via the public switched telephone network (PSTN) preferably using known encryption algorithms for confidential data but is preferably via a private network and encrypted. The firewall 4 allows communications with the secure web server 1 using an encrypted communications protocol such as the Hypertext Transfer Protocol (HTTP) over a Secure Sockets Layer (SSL). The firewall 4 connects the protected network 2 to the public or private network 3 using either an Internet service provider (ISP), leased, or owned telecommunications equipment/circuits 5 having appropriate bandwidth capability (although the data may be suitably compressed via known compression algorithms and transmitted over lower bandwidth facilities). The connection to the firewall 4 and all connections and equipment collocated with the protected network 2 are housed in a secure server facility 6 that provides DNA analysis services to a community of clients located at forensic laboratories 7 or other organizations. Location 7, 8, 9 is shown by way of example only and is no way intended to be limited to forensic laboratory locations.

A client 8 located at a forensic laboratory or other organization may use the public or private network 3 to gain access to software services offered by the secure server facility 6. Preferably, the client 8 is connected to a protected network 9 which connects to the public or private network 3 through a firewall 10, and the firewall 10, the protected network 9, and all equipment connected to the protected network 9, such as the Database Client 8, are housed in a secure client facility such as a forensic laboratory 7 (or other secure facility). The firewall 10 located at the forensic laboratory 7 connects the protected network 9 to the public or private network 3 using either an ISP, leased, or owned telecommunications equipment/circuits 11 having similar bandwidth considerations as described above for equipment/circuits 5.

The client 8 may make requests to analyze data derived from DNA mixtures on the secure web server 1 by accessing the secure web server 1, transmitting DNA mixture data to the secure web server, and receiving analysis results. These results may then be interpreted using mixture interpretation guidelines to obtain one or more DNA profiles that may be associated with a suspect to a crime.

Optionally, the Database Client 8 may access a local laboratory, state, or national DNA database 12 to search for matches to the one or more DNA profiles formed using the results of the LSD analysis. The DNA database 12 may be located in a separate secure facility at the state, local, or national level and is preferentially protected by a firewall 13. The firewall 13 is connected to the public or private network using either an ISP, leased, or owned telecommunications equipment/circuits 14, and preferentially allows communications with a DNA database server 12 using only an encrypted communications protocol such as HTTP over SSL. The firewall 13 and DNA database server 12 are connected to a protected network 15. The connections to the firewall 13 and all connections and equipment collocated with the protected network 15 are housed in a secure server facility 16 that provides DNA database services to a community of clients located at forensic laboratories 7 or other organizations.

Nothing shown in FIG. 11 or described above should be taken to restrict the domain of the invention. For example, the DNA database server and the secure service server may be connected through firewalls to two separate and isolated public or private networks, requiring a separate client and protected network located at a forensic laboratory in order to communicate with each server. This is the case at present with the FBI's National DNA Index System (NDIS), which is connected to state and local facilities through the FBI-owned and operated Criminal Justice Information System's Wide Area Network (CJIS-WAN), and with the current implementation of the secure LSD server. An investigator or analyst transfers results obtained by a client from the secure service server to a client computer of the FBI's NDIS facilities in order to perform a search on the national DNA database.

The invention is not restricted to operation on protected computers and networks, nor is it restricted to require security of communications using encryption and secure authentication protocols. However, these measures are usually necessitated by the privacy laws of the United States and other countries. In a similar manner, it is not required that the implementing software, Database Client, and DNA database software operate on separate and communicating computers. They may in fact all be installed and operated on a single computer in some applications, or on two computers. There may also be multiple instances of the DNA database software running on several computers. The realities of multiple jurisdictions and multiple ownership of and responsibility for controlled access to data that are considered sensitive usually necessitates the use of multiple computers under the control of independent but cooperating agencies.

The output of the system embodiment of the invention is shown if FIGS. 12-20 which was generated using an EXCEL TM VBA Application platform (Microsoft, Redmond, Wash.). However, it is understood that other software vehicle are also appropriate for reproducing the system embodiment of this invention, including, by way of non-limiting example, VISUAL BASIC (Microsoft, Redmond, Wash.) and MATLAB (Mathworks, Natick, Mass.) implementations.

Various features of novelty that characterize the invention are pointed out with particularity in the claims annexed to and forming a part of this disclosure. For a better understanding of the invention, its operating advantages and specific objects attained by its uses, reference is made to the accompanying drawings and descriptive in which a preferred embodiment of the invention is illustrated.

Numerous modifications and variations of the present invention are included in the above-identified specification and are expected to be obvious to one of skill in the art. Such modifications and alterations to the compositions and processes of the present invention are believed to be encompassed in the scope of the claims appended hereto.

### REFERENCES

The contents of each of which, and the contents of every other publication, including patent publications such as PCT International Patent Publications, being incorporated herein by this reference.)
1. Mullis, K., et al., Specific enzymatic amplification of DNA in vitro: the polymerase chain reaction. Cold Spring Harb Symp Quant Biol, 1986. 51 Pt 1: p. 263-73.
2. Weber, J. L. and P. E. May, Abundant class of human DNA polymorphisms which can be typed using the polymerase chain reaction. Am J Hum Genet, 1989. 44(3): p. 388-96.
3. Perlin, M. W., G. Lancia, and S. K. Ng, Toward fully automated genotyping: genotyping microsatellite markers by deconvolution. Am J Hum Genet, 1995. 57(5): p. 1199-210.
4. Perlin, M. W. and B. Szabady, Linear mixture analysis: a mathematical approach to resolving mixed DNA samples. J Forensic Sci, 2001. 46(6): p. 1372-8.
5. Clayton, T. M., et al., Analysis and interpretation of mixed forensic stains using DNA STR profiling. Forensic Sci Int, 1998. 91(1): p. 55-70.
6. Gill, P., et al., Interpreting simple STR mixtures using allele peak areas. Forensic Sci Int, 1998. 91(1): p. 41-53.
7. Perlin, M. W. Scientific Validation of Mixture Interpretation Methods. in Seventeenth International Symposium on Human Identification. 2006: Cybergenetics.
8. Gill, P., et al., DNA commission of the International Society of Forensic Genetics: Recommendations on the interpretation of mixtures. Forensic Sci Int, 2006. 160(2-3): p. 90-101.
9. Balding, D. J., Weight-of-evidence for forensic DNA profiles. Statistics in practice. 2005, Hoboken, N.J.: John Wiley & Sons. x, 184 p.
10. Buckleton, J. S., C. M. Triggs, and S. J. Walsh, Forensic DNA evidence interpretation. 2005, Boca Raton: CRC Press. 534 p.
11. Ladd, C., et al., Interpretation of complex forensic DNA mixtures. Croat Med J, 2001. 42(3): p. 244-6.
12. Buckleton, J. and C. Triggs, Is the 2p rule always conservative? Forensic Sci Int, 2006. 159(2-3): p. 206-9.
13. Bill, M., et al., PENDULUM—a guideline-based approach to the interpretation of STR mixtures. Forensic Sci Int, 2005. 148(2-3): p. 181-9.
14. Evett, I. W., P. D. Gill, and J. A. Lambert, Taking account of peak areas when interpreting mixed DNA profiles. J Forensic Sci, 1998. 43(1): p. 62-9.
15. Evett, I. W., et al., A guide to interpreting single locus profiles of DNA mixtures in forensic cases. J Forensic Sci Soc, 1991. 31 (1): p. 41-7.
16. Weir, B. S., et al., Interpreting DNA mixtures. J Forensic Sci, 1997. 42(2): p. 213-22.
17. Gill, P., R. Sparkes, and C. Kimpton, Development of guidelines to designate alleles using an STR multiplex system. Forensic Sci Int, 1997. 89(3): p. 185-97.
18. Wang, T., N. Xue, and J. D. Birdwell, Least-square deconvolution: a framework for interpreting short tandem repeat mixtures. J Forensic Sci, 2006. 51(6): p. 1284-97.

What is claimed is:

1. A method of resolving a mixture comprising DNA of more than one individual into genotype profiles for individuals in the mixture comprising:
(a) obtaining quantitative allele peak data for alleles present at a first locus in a DNA mixture comprising DNA of more than one individual;
(b) transforming the quantitative allele peak data using a machine to produce individual DNA profiles from the DNA mixture, said transformation comprising the steps of:
1) assuming, whenever possible that allele peak ratios at the first locus are equal to 1;
2) assuming, whenever possible, that shared common alleles at the first locus are shared in the proportion of the non-common alleles sharing the common allele;
3) ensuring that a minimum peak height is maintained across all alleles at the first locus;
4) calculating the proportion of each allele combination at the first locus;
5) calculating a peak height ratio for each allele combination at the first locus;
6) presenting the transformed quantitative allele peak data in a machine readable form, said transformed data comprising allele combinations.

2. The method of claim 1 wherein the quantitative allele peak data are measurements of relative fluorescence units (RFUs).

3. The method of claim 1 wherein the step of obtaining the quantitative allele peak data comprises an amplification reaction.

4. The method of claim 1 wherein the first locus harbors short tandem repeats (STRs).

5. The method of claim 4 wherein the first locus is selected from the group consisting of CSF1PO, FGA, TH01, TPOX, VWA, D3S1358, D5S818, D7S820, D8S1179, D13S317, D16S539, D18S51, and D21 S11.

6. The method of claim 4 wherein the first locus is selected from the group consisting of HUMVWFA31, HUMTH01, D21S11, D18S51, HUMFIBRA, D8S1179, HUMAMGXA, HUMAMGY, D3S1358, HUMVWA, D16S539, D2S1338, Amelogenin, D8S1179, D21S11, D18S51, D19S433, HUMTH01, and HUMFIBRA/FGA.

7. The method of claim 1 wherein one of the more than one individual is known.

8. The method of claim 7 further comprising: obtaining a known genotype profile of the known individual; and, comparing the known genotype profile of the known individual to the respective genotype profiles for the individuals in the mixture.

9. The method of claim 1 further comprising a step of: limiting allele combinations presented after the transforming step by applying the at least one reference sample.

10. The method of claim 1 further comprising a step of: limiting allele combination presented after the transforming step by applying user-defined parameters selected from a group consisting of: a minimum contributor proportion, a minimum peak height, and a minimum peak height ratio.

11. The method of claim 1 further comprising a step of: searching for a match for at least one of the respective genotype profiles with a known genotype profile in a database comprising known genotype profiles.

12. The method of claim 11 wherein the database is a convicted offenders DNA database.

13. The method of claim 11 wherein the database is a forensic database.

14. The method of claim 11 wherein the database is implemented using any version of the Combined DNA Index System (CODIS) software.

15. The method of claim 1 further comprising the step of: (c) repeating the steps (a) and (b) for a second locus.

16. The method of claim 15 further comprising the step (d) repeating the steps (a) and (b) for a third and subsequent loci.

17. The method of claim 15 wherein genotype profiles of the first locus and the second locus are compiled to form a composite genotype profile.

18. The method of claim 16 wherein genotype profiles of the first, second, third and subsequent loci are compiled to form a composite genotype profile.

19. The method of claim 1 wherein the DNA mixture is processed for PCR artifacts.

20. The method of claim 19 wherein the artifacts comprise stutter.

21. The method of claim 1 wherein the transformed quantitative allele peak data is analyzed and an output is produced.

22. The method of claim 21 wherein the analysis comprises a statistical calculation.

23. The method of claim 22 wherein the analysis comprises a likelihood ratio calculation.

24. The method of claim 22 wherein the analysis comprises a hypothesis test.

25. The method of claim 21 wherein the output is a profile summary.

26. The method of claim 21 wherein the output is a graph of contributor contribution proportions.

27. The method of claim 1 wherein step (a) further comprises: calculating an upper and lower boundary condition at the first locus of a three-person mixture and eliminating allele combinations at the first locus that do not meet the upper and lower boundary conditions calculated.

28. A method of resolving a mixture comprising DNA of more than one individual into genotype profiles for individuals in the mixture comprising:
(a) obtaining quantitative allele peak data for alleles present at a first locus in a DNA mixture comprising DNA of more than one individual;
(b) defining a minimum contributor proportion;
(c) defining a minimum peak height;
(d) defining a minimum peak height ratio;
(e) selecting at least one reference sample;
(f) calculating the total sum of all relative fluorescent units at the at the first locus;
(g) transforming the quantitative allele peak data using a machine to produce individual DNA profiles from the DNA mixture, said transformation comprising the steps of:
1) assuming, whenever possible that allele peak ratios at the first locus are equal to 1;
2) assuming, whenever possible, that shared common alleles at the first locus are shared in the proportion of the non-common alleles sharing the common allele,
3) ensuring that minimum peak height defined in step (c) is maintained across all alleles at the first locus;
4) calculating the proportion of each allele combination at the first locus to the sum calculated at step (f);
5) calculating a peak height ratio for each allele combination at the first locus;
6) presenting the transformed quantitative allele peak data in a machine readable form, said transformed data comprising allele combinations;
(h) limiting allele combinations presented after the transforming step by applying the at least one reference sample from step (e) resulting in a first output;
(i) limiting allele combination presented in the first output by applying the parameters defined in steps (b), (c) and (d) resulting in a second output;
(j) allowing a user to consider one or more alleles extraneous to the calculation; and,
(k) repeating the steps (a) and (f) through (j) for a second locus.

29. The method of claim 28 wherein the DNA mixture is processed for PCR artifacts.

30. The method of claim 29 wherein the artifacts comprise stutter.

31. The method of claim 28 wherein said second output is analyzed.

32. The method of claim 31 wherein the analysis comprises a statistical calculation.

33. The method of claim 32 wherein the analysis comprises a likelihood ratio calculation.

34. The method of claim 32 wherein the analysis comprises a hypothesis test.

35. The method of claim 28 wherein the second output is a profile summary.

36. The method of claim 28 wherein the second output is a graph of contributor contribution proportions.

37. The method of claim 28 wherein the quantitative allele peak data are measurements of relative fluorescence units (RFUs).

38. The method of claim 28 wherein the step of obtaining the quantitative allele peak data comprises an amplification reaction.

39. The method of claim 28 wherein the first locus harbors short tandem repeats (STRs).

40. The method of claim 39 wherein the first locus is selected from the group consisting of CSF1PO, FGA, TH01, TPOX, VWA, D3S1358, D5S818, D7S820, D8S1179, D13S317, D16S539, D18S51, and D21S11.

41. The method of claim 39 wherein the first locus is selected from the group consisting of HUMVWFA31, HUMTH01, D21S11, D18S51, HUMFIBRA, D8S1179, HUMAMGXA, HUMAMGY, D3S1358, HUMVWA, D16S539, D2S1338, Amelogenin, D8S1179, D21S11, D18S51, D19S433, HUMTH01, and HUMFIBRA/FGA.

42. The method of claim 28 wherein one of the more than one individual is known.

43. The method of claim 42 further comprising:
obtaining a known genotype profile of the known individual; and,
comparing the known genotype profile of the known individual to the respective genotype profiles for the individuals in the mixture.

44. The method of claim 28 further comprising a step of: searching for a match for at least one of the respective genotype profiles with a known genotype profile in a database comprising known genotype profiles.

45. The method of claim 44 wherein the database is a convicted offenders DNA database.

46. The method of claim 44 wherein the database is a forensic database.

47. The method of claim 44 wherein the database is implemented using any version of the Combined DNA Index System (CODIS) software.

48. The method of claim 28 further comprising the steps of: calculating an upper and lower boundary condition at the first locus for three person mixtures; eliminating the allele combinations at the first locus that do not meet the calculated upper and lower boundary conditions, and; reporting possible allele combinations.

49. A computer program product embodied on one or more computer-usable medium for deconvoluting DNA mixtures comprising:
(a) a first computer-readable program code means for transforming quantitative allele peak data according to the method described in claim 1;
(b) a second computer-readable program code means for analyzing the transformed quantitative allele peak data; and,
(c) a third computer-readable program code for displaying the analyzed transformed quantitative allele peak data.

50. The computer program product of claim 49 further comprising:
(d) a fourth computer-readable program code for calculating lower and upper boundary conditions for allele combinations from three-person mixtures and eliminating allele combinations that do not fall within the boundary conditions; and,
(e) a fifth computer-readable program code displaying the allele combinations that do fall within the boundary conditions.

51. A computer program product embodied on one or more computer-usable medium for deconvoluting DNA mixtures comprising:
(a) a first computer-readable program code means for transforming quantitative allele peak data according to the method described in claim 28;
(b) a second computer-readable program code means for analyzing the transformed quantitative allele peak data; and,
(c) a third computer-readable program code for displaying the analyzed transformed quantitative allele peak data.

52. The computer program product of claim 51 further comprising:
(d) a fourth computer-readable program code for calculating lower and upper boundary conditions for allele combinations from three-person mixtures and eliminating allele combinations that do not fall within the boundary conditions; and,
(e) a fifth computer-readable program code displaying the allele combinations that do fall within the boundary conditions.

53. A method according to claim 1 wherein a user is allowed to consider one or more alleles extraneous to the calculation.

54. A system of resolving a mixture comprising DNA of more than one individual into genotype profiles for individuals in the mixture comprising:
computing means;
instructions contained on computer readable media for transforming quantitative allele peak data at a given locus by automatically performing the steps of:
(a) obtaining quantitative allele peak data for alleles present at a first locus in a DNA mixture comprising DNA of more than one individual;
(b) defining a minimum peak height;
(c) defining a minimum peak height ratio;
(d) calculating a peak height ratio for all possible allele combinations that can be contributed by the individuals of the more than one individual at the first locus;
(e) calculating the total sum of all relative fluorescent units at the at the first locus;
(f) calculating the proportion of total relative fluorescent units of all possible allele combinations that can be contributed by the individuals of the more than one individual at the first locus compared to the sum calculated in step (e);
(g) performing an analysis on the data generated in step (f) assuming that, whenever possible:
combined allele peak ratios are equal to 1;
shared alleles are shared in the proportion of the alleles sharing the allele; and,
that minimum peak heights are maintained;

55. The system of claim 54, further comprising input means to allow a user to consider one or more alleles extraneous to a calculation.

56. The system of claim 54, further comprising input means to allow a user to set references.

57. The system of claim 54, further comprising input means to allow a user to set default parameters.

58. The system of claim 54, further comprising means for generating statistical data.

59. The system of claim 54, further comprising means for limiting allele combinations based on applied user-defined references.

60. The system of claim 54, further comprising means for limiting allele combinations based on applied user-defined parameters.

61. The system of claim 54, further comprising means for generating reports.

62. The system of claim 54, further comprising display means.

63. The system of claim 54, further comprising data storage means.

64. The system of claim 54, further comprising communications means.

65. A system of resolving a mixture comprising DNA of more than one individual into genotype profiles for individuals in the mixture comprising:
computing means;
data storage means;
communications means;
input means comprising an interface to allow a user to consider one or more alleles extraneous to a calculation;
input means comprising an interface to allow a user to set references;
input means comprising an interface to allow a user to set default parameters;
instructions contained on computer readable media for transforming quantitative allele peak data at a given locus by automatically performing the steps of:
(a) obtaining quantitative allele peak data for alleles present at a first locus in a DNA mixture comprising DNA of more than one individual;
(b) defining a minimum peak height;
(c) defining a minimum peak height ratio;
(d) calculating a peak height ratio for all possible allele combinations that can be contributed by the individuals of the more than one individual at the first locus;
(e) calculating the total sum of all relative fluorescent units at the at the first locus;
(f) calculating the proportion of total relative fluorescent units of all possible allele combinations that can be contributed by the individuals of the more than one individual at the first locus compared to the sum calculated in step (e);
(g) performing an analysis on the data generated in step (f) assuming that, whenever possible:
combined allele peak ratios are equal to 1;
shared alleles are shared in the proportion of the alleles sharing the allele; and,
that minimum peak heights are maintained;
(h) generating statistical data;
(i) limiting allele combinations based on applied user-defined references;
(j) limiting allele combinations based on applied user-defined parameters;
(k) generating reports;
display means for visually displaying the reports.
